(19) United States
(12) Patent Application Publication
(10) Pub. No.: US 2014/0251546 A1
(43) Pub. Date: Sep. 11, 2014

(54) PEELING DEVICE, PEELING SYSTEM AND PEELING METHOD

(71) Applicant: TOKYO ELECTRON LIMITED, Tokyo (JP)

(72) Inventors: Masatoshi DEGUCHI, Kikuchi-gun (JP); Takashi SAKAUE, Kikuchi-gun (JP); Kei TASHIRO, Kikuchi-gun (JP); Masanori ITOU, Koshi City (JP)

(73) Assignee: TOKYO ELECTRON LIMITED, Tokyo (JP)

(21) Appl. No.: 14/198,147

(22) Filed: Mar. 5, 2014

(30) Foreign Application Priority Data
Mar. 7, 2013 (JP) 2013-045969

(51) Int. Cl. B32B 43/00

(52) U.S. Cl. CPC B32B 43/006
USPC 156/702; 156/751

(57) ABSTRACT

A peeling device according to the present disclosure includes a holding unit, a plurality of suction moving units, a state detection unit and a control unit. The holding unit is configured to hold a first substrate of a superposed substrate having the first substrate and a second substrate joined. The suction moving units are configured to suction-hold the second substrate of the superposed substrate and move the second substrate in a direction away from a surface of the first substrate. The state detection unit is configured to detect a peeled-off state of the second substrate from the first substrate. The control unit is configured to control operation timings of the suction moving units so that the second substrate is peeled off from the first substrate gradually from one end of the second substrate toward the other end thereof, based on the peeled-off state detected by the state detection unit.

### CROSS-REFERENCE TO RELATED APPLICATION

This application claims the benefit of Japanese Patent Application No. 2013-045969, filed on Mar. 7, 2013, in the Japan Patent Office, the disclosure of which is incorporated herein in its entirety by reference.

### TECHNICAL FIELD

The present disclosure relates to a peeling device, a peeling system and a peeling method.

### BACKGROUND

In recent years, enlargement in diameter and reduction in thickness have progressed with respect to semiconductor substrates such as silicon wafers or compound semiconductor wafers used, for example, in a process of manufacturing a semiconductor device. A thin large-diameter substrate is likely to be bent or broken when the substrate is transferred or polished. For this reason, after the semiconductor substrate is joined to a support substrate to be reinforced, the semiconductor substrate is transferred or polished, and then, the support substrate is peeled off from the semiconductor substrate.

For example, there has been disclosed a conventional technique of peeling off a support substrate from a semiconductor substrate by holding the semiconductor substrate and the support substrate with a first holding unit and a second holding unit, respectively, and then moving an outer peripheral portion of the second holding unit in the vertical direction.

However, the above-described conventional technique still has a problem in that the efficiency of its peeling process should be improved. Improvement of an efficiency of the peeling process may be also a problem, e.g., in a process of manufacturing an SOI (silicon on insulator) involving such a substrate peeling process.

### SUMMARY

Some embodiments of the present disclosure provide to a peeling device, a peeling system and a peeling method capable of promoting efficiency of peeling process.

According to one embodiment of the present disclosure, there is provided a peeling device including a holding unit configured to hold a first substrate of a superposed substrate, the superposed substrate having the first substrate and a second substrate joined, a plurality of suction moving units configured to suction-hold the second substrate of the superposed substrate and move the second substrate in a direction away from a surface of the first substrate, a state detection unit configured to detect a peeled-off state of the second substrate from the first substrate, and a control unit configured to control operation timings of the suction moving units so that the second substrate is peeled off from the first substrate gradually from one end of the second substrate toward the other end thereof, based on the peeled-off state detected by the state detection unit.

According to another embodiment of the present disclosure, there is provided a peeling system including a carry-in/carry-out station in which a superposed substrate is mounted, the superposed substrate having a first substrate and a second substrate joined, a substrate transfer device configured to transfer the superposed substrate mounted in the carry-in/carry-out station, and a peeling station provided with a peeling device configured to peel off the first substrate and the second substrate from the superposed substrate transferred by the substrate transfer device, wherein the peeling device including a holding unit configured to hold the first substrate of the superposed substrate, a plurality of suction moving units configured to suction-hold the second substrate of the superposed substrate and move the second substrate in a direction away from a surface of the first substrate, a state detection unit configured to detect a peeled-off state of the second substrate from the first substrate, and a control unit configured to control operation timings of the suction moving units so that the second substrate is peeled off from the first substrate gradually from one end of the second substrate toward the other end thereof, based on the peeled-off state detected by the state detection unit.

According to still another embodiment of the present disclosure, there is provided a peeling method including holding a first substrate of a superposed substrate by a holding unit, the holding unit being configured to hold the first substrate of the superposed substrate, and the superposed substrate having the first substrate and a second substrate joined, detecting a peeled-off state of the second substrate from the first substrate, and controlling operation timings of a plurality of suction moving units so that the second substrate is peeled off from the first substrate gradually from one end of the second substrate toward the other end thereof by the plurality of suction moving units, based on the peeled-off state detected in the detecting process, the plurality of suction moving units being configured to suction-hold the second substrate of the superposed substrate and move the second substrate in a direction away from a surface of the first substrate.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1A is a schematic plan view illustrating a configuration of a peeling system according to a first embodiment.

FIG. 1B is a schematic side view of a superposed substrate.

FIG. 2A is a schematic plan view of the superposed substrate held by a dicing frame.

FIG. 2B is a schematic side view of the superposed substrate held by the dicing frame.

FIG. 2C is a schematic enlarged view of the vicinity of the dicing frame of FIG. 2B.

FIG. 3A is a schematic side view illustrating a configuration of a peeling device according to the first embodiment.

FIG. 3B is a partially enlarged side view schematically illustrating the configuration of the peeling device shown in FIG. 3A.

FIG. 4A is an explanatory view illustrating the operation of peeling inducement processing.

FIG. 4B is an explanatory view illustrating the operation of the peeling inducement processing.

FIG. 4C is an explanatory view illustrating the operation of the peeling inducement processing.

FIG. 5 is a schematic plan view illustrating a positional relationship between a support substrate and suction pads of first to third suction moving units.

FIG. 6 is a flowchart illustrating processing sequences of the peeling process.

FIG. 7A is an explanatory view of the peeling operation by the peeling device.

FIG. 7B is an explanatory view of the peeling operation by the peeling device.

FIG. 7C is an explanatory view of the peeling operation by the peeling device.

FIG. 7D is an explanatory view of the peeling operation by the peeling device.

FIG. 7E is an explanatory view of the peeling operation by the peeling device.

FIG. 7F is an explanatory view of the peeling operation by the peeling device.

FIG. 7G is an explanatory view of the peeling operation by the peeling device.

FIG. 7H is an explanatory view of the peeling operation by the peeling device.

FIG. 7I is an explanatory view of the peeling operation by the peeling device.

FIG. 8A is a schematic plan view illustrating a modified example of a second holding unit.

FIG. 8B is a schematic plan view illustrating a modified example of the second holding unit.

FIG. 8C is a schematic plan view illustrating a modified example of the second holding unit.

FIG. 9 is a schematic plan view illustrating a positional relationship between the support substrate, the suction pads of the first to third suction moving units and a peeling completion detection unit in a modified example of the peeling device according to the first embodiment.

FIG. 10 is a flowchart illustrating processing sequences of a peeling process based on a detection result of the peeling completion detection unit.

FIG. 11 is a schematic plan view illustrating a positional relationship between the support substrate, the suction pads of the first to third suction moving units and state detection units in a peeling system according to a second embodiment.

FIG. 12A is a schematic view illustrating a manufacturing process of an SOI substrate.

FIG. 12B is a schematic view illustrating the manufacturing process of the SOI substrate.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Hereinafter, embodiments of a peeling device, a peeling system and a peeling method of the present disclosure will be described in detail with reference to the accompanying drawings. The present disclosure is not limited to the embodiments described.

### First Embodiment

### 1. Peeling System

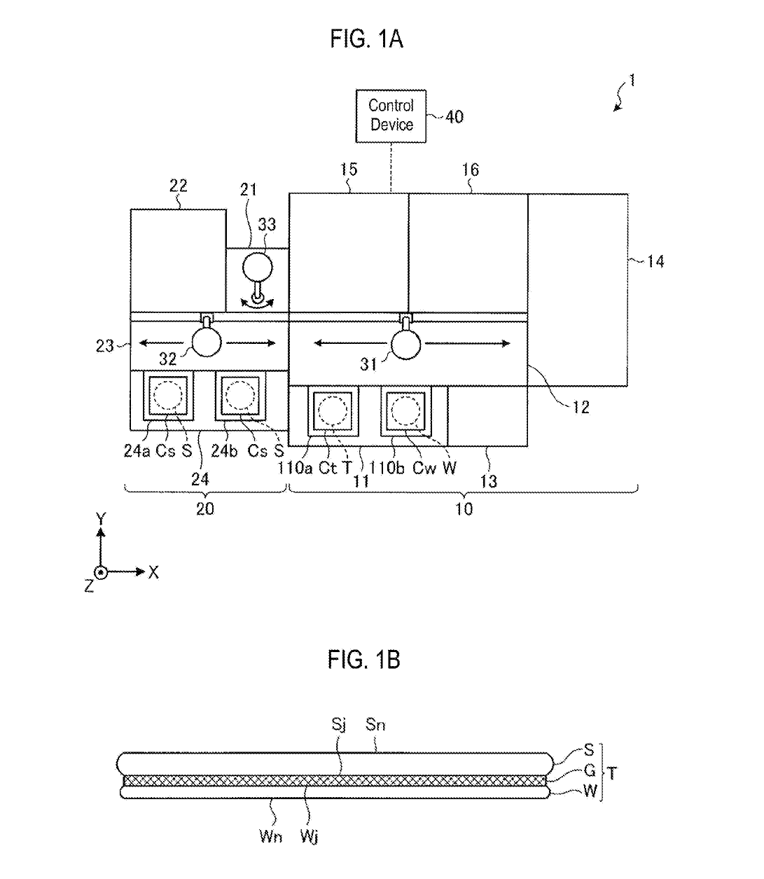

First, a configuration of a peeling system according to a first embodiment will be described with reference to FIGS. 1A and 1B. FIG. 1A is a schematic plan view illustrating the configuration of the peeling system according to the first embodiment, and FIG. 1B is a schematic side view of a superposed substrate.

In addition, hereinafter, in order to make a positional relationship clear, X, Y and Z axis directions perpendicular to one another are defined, and the positive direction of the Z axis is defined as the vertically upward direction.

A peeling system 1 according to the first embodiment shown in FIG. 1A peels off a target substrate W to be processed and a support substrate S from a superposed substrate T (see FIG. 1B), in which the target substrate W and the support substrate S are joined through an adhesive G.

Hereinafter, as shown in FIG. 1B, a surface of the target substrate W to be joined to the support substrate S through the adhesive G will be referred to as a “joint surface Wj”, and a surface of the target substrate W opposite to the joint surface Wj will be referred to as a “non-joint surface Wn”. Also, a surface of the support substrate S to be joined to the target substrate W through the adhesive G will be referred to as a “joint surface Sj”, and a surface of the support substrate S opposite the joint surface Sj will be referred to as a “non-joint surface Sn”.

The target substrate W is a semiconductor substrate, such as a silicon wafer or a compound semiconductor wafer, having a plurality of electronic circuits formed thereon, wherein the surface for the electronic circuits to be formed thereon is defined as the joint surface Wj. In addition, the target substrate W is thinned by, for example, polishing the non-joint surface Wn. Specifically, the target substrate W has a thickness of about 20 to 50 μm.

In the meantime, the support substrate S is a substrate having substantially the same diameter as that of the target substrate W and supports the target substrate W. The support substrate S has a thickness of about 650 to 800 μm. The support substrate S may include a glass substrate or the like, in addition to a silicon wafer. In addition, the adhesive G through which the target substrate W and the support substrate S are joined has a thickness of about 10 to 150 μm.

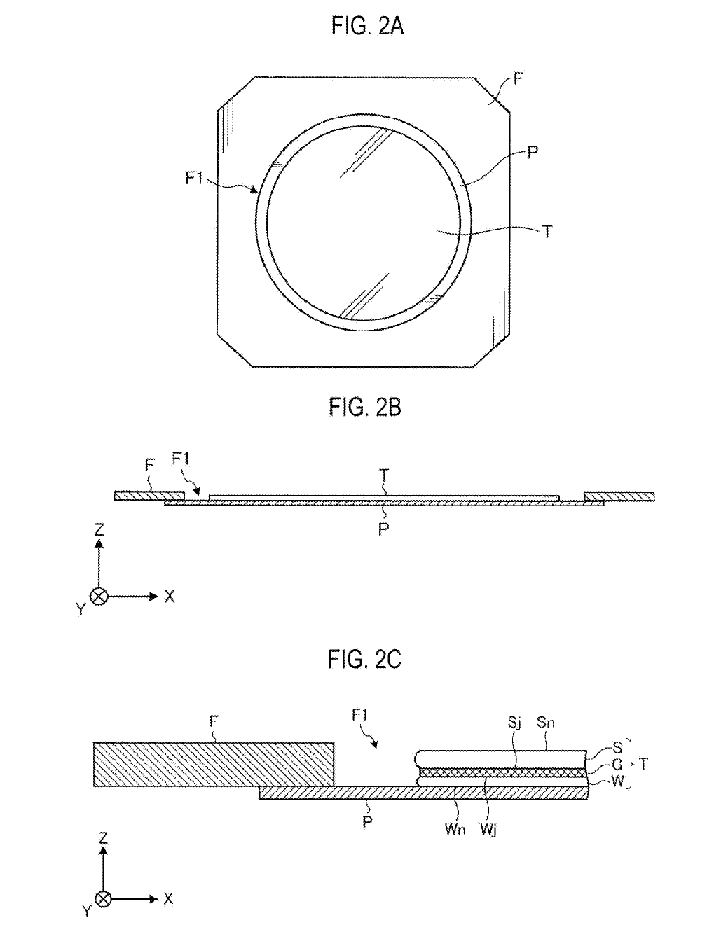

The superposed substrate T is protected by attaching a dicing frame thereto. Here, a configuration of the dicing frame will be described with reference to FIGS. 2A to 2C. FIGS. 2A and 2B are respectively a schematic plan view and a schematic side view of the superposed substrate T held by the dicing frame. Also, FIG. 2C is a schematic enlarged view of the vicinity of the dicing frame of FIG. 2B.

As shown in FIGS. 2A and 2B, a dicing frame F is a substantially annular metal member, in which an opening F1 having a diameter larger than that of the superposed substrate T is formed at the center thereof. The dicing frame F has a thickness of about 1.5 mm.

The opening F1 of the dicing frame F is provided with an adhesive member referred to as a dicing tape P in a tensioned state. Specifically, as a peripheral portion of the dicing tape P is fixed to a rear face of the dicing frame F, the dicing tape P is installed over the opening F1 of the dicing frame F in a tensioned state.

The dicing tape P has a sticky layer formed on a front surface thereof, and the superposed substrate T is attached to the sticky layer. As shown in FIG. 2C, the superposed substrate T is attached to the front surface of the dicing tape P on the rear surface, i.e., the non-joint surface Wn, of the target substrate. With this configuration, the superposed substrate T is held by the dicing frame F through the dicing tape P.

As shown in FIG. 1A, the peeling system 1 according to the first embodiment is provided with a first processing block 10 and a second processing block 20. The first processing block 10 and the second processing block 20 are arranged and disposed in named order along the negative X axis direction.

The first processing block 10 is a block that performs the processing on the substrate held by the dicing frame F, specifically, the superposed substrate T or the target substrate W after being peeled. The first processing block 10 is provided with a carry-in/carry-out station 11, a first transfer region 12, a standby station 13, an edge cutting station 14, a peeling station 15, and a first cleaning station 16.

In addition, the second processing block 20 is a block that performs the processing on the substrate not held by the dicing frame F, specifically, the support substrate S after being peeled off. The second processing block 20 is provided with a delivery station 21, a second cleaning station 22, a second transfer region 23 and a carry-out station 24.

The first transfer region 12 of the first processing block 10 and the second transfer region 23 of the second processing block 20 are arranged and disposed in the X axis direction. In addition, the carry-in/carry-out station 11 and the standby station 13 are arranged and disposed in this order in the X axis direction at a back side of the first transfer region 12 along the Y axis direction, and the carry-out station 24 is disposed at a back side of the second transfer region 23 along the Y axis direction.

In addition, the peeling station 15 and the first cleaning station 16 are arranged and disposed in this order in the X axis direction at a side opposite the carry-in/carry-out station 11 and the standby station 13 about the first transfer region 12. Also, the delivery station 21 and the second cleaning station 22 are arranged and disposed in this order in the negative X axis direction at a side opposite the carry-out station 24 about the second transfer region 23. Further, the edge cutting station 14 is disposed at a side of the first transfer region 12 facing the positive X axis direction.

First, a configuration of the first processing block 10 will be described. A cassette Ct having the superposed substrates T held by the dicing frames F accommodated therein and a cassette Cw having the target substrates W to be processed after being peeled accommodated therein are carried in and out between the carry-in/carry-out station 11 and the outside thereof. The carry-in/carry-out station 11 is provided with a cassette mounting table, and the cassette mounting table is provided with a plurality of cassette loading plates 110a and 110b on which the cassettes Ct and Cw are mounted, respectively.

In the first transfer region 12, the superposed substrate T or the target substrate W after being peeled is transferred. The first transfer region 12 is provided with a first transfer device 31 configured to transfer the superposed substrate T or the target substrate W after being peeled.

The first transfer device 31 is a substrate transfer device having a transfer arm unit capable of moving in the horizontal and the vertical direction and rotating around an axis of the vertical direction, and a substrate holding unit attached to a leading end of the transfer arm unit. The first transfer device 31 holds a substrate using the substrate holding unit and transfers the substrate held by the substrate holding unit to a desired place by the transfer arm unit.

In addition, the substrate holding unit of the first transfer device 31 holds the dicing frame F by suction-holding or gripping it, and at this moment the superposed substrate T or the target substrate W after being peeled is held in the same orientation as an approximate horizontal plane.

An ID (identification) reading device configured to read an ID of the dicing frame F is disposed in the standby station 13, and the superposed substrate T that is being processed can be identified by the ID reading device.

In the standby station 13, in addition to the reading processing of the ID, a standby processing, which allows the superposed substrate T to be temporarily in a processing standby state, is performed, as necessary. The standby station 13 is provided with a mounting table on which the superposed substrate T transferred by the first transfer device 31 is mounted. The ID reading device and a temporary standby section are formed on the mounting table.

In the edge cutting station 14, an edge cutting processing to remove a peripheral portion of the adhesive G (see FIG. 1B) by dissolving it with a solvent is performed. As the edge cutting processing causes the peripheral portion of the adhesive G to be removed, in the later-described peeling process, the target substrate W and the support substrate S can be easily peeled off from each other. The edge cutting station 14 is provided with an edge cutting device, which dissolves the peripheral portion of the adhesive G with the solvent of the adhesive G by immersing the superposed substrate T in the solvent.

The peeling station 15 performs the peeling process, in which the target substrate W and the support substrate S are peeled off from the superposed substrate T transferred by the first transfer device 31. The peeling station 15 is provided with a peeling device configured to perform the peeling process. The specific configuration and operation of the peeling device will be described later.

The first cleaning station 16 performs cleaning processing on the target substrate W after being peeled. The first cleaning station 16 is provided with a first cleaning device configured to clean the target substrate W after being peeled in a state of being held by the dicing frame F. As the first cleaning device, for example, a cleaning device described in Japanese Patent Laid-Open Publication No. 2013-033925 may be used.

In such a first processing block 10, the ID reading processing is performed on the dicing frame F in the standby station 13, the edge cutting processing is performed on the superposed substrate T in the edge cutting station 14, and then, the peeling process is performed on the superposed substrate T in the peeling station 15. Also, in the first processing block 10, after the target substrate W after being peeled is cleaned in the first cleaning station 16, the target substrate W after being cleaned is transferred to the carry-in/carry-out station 11. Thereafter, the target substrate W after being cleaned is carried out of the carry-in/carry-out station 11.

Next, a configuration of the second processing block 20 will be described. In the delivery station 21, a delivery is performed, i.e. receiving the support substrate S after being peeled off from the peeling station 15 and transfer it to the second cleaning station 22. The delivery station 21 is provided with a third transfer device 33 configured to hold the support substrate S after being peeled off in a contactless manner and transfer it, and the delivery described above in the delivery station 21 is performed by the third transfer device 33.

In the second cleaning station 22, second cleaning processing is performed to clean the support substrate S after being peeled off. The second cleaning station 22 is provided with a second cleaning device configured to clean the support substrate S after being peeled off. As the second cleaning device, for example, the cleaning device described in Japanese Patent Laid-Open Publication No. 2013-033925 may be used.

In the second transfer region 23, the support substrate S cleaned by the second cleaning device is transferred. The second transfer region 23 is provided with a second transfer device 32 configured to transfer the support substrate S.

The second transfer device 32 is a substrate transfer device that includes a transfer arm unit capable of moving in the horizontal and vertical directions and rotating around an axis parallel to a vertical direction, and a substrate holding unit attached to a leading end of the transfer arm unit. The second transfer device 32 holds a substrate using the substrate holding unit and transfers the substrate held by the substrate holding unit to the carry-out station 24 by the transfer arm unit. In addition, the substrate holding unit of the second transfer device 32 is a fork or the like configured to hold the support substrate S in a same orientation as an approximately horizontal plane, for example, by supporting the support substrate S from the bottom.

In the carry-out station 24, cassettes Cs each having the support substrates S accommodated therein are carried in and out between the carry-out station 24 and the outside thereof. The carry-out station 24 is provided with a cassette mounting table, and the cassette mounting table is provided with a plurality of cassette loading plates 24a and 24b on which the cassettes Cs are mounted.

In the second processing block 20, the support substrate S after being peeled off is transferred from the peeling station 15 to the second cleaning station 22 through the delivery station 21, and is cleaned in the second cleaning station 22. Thereafter, in the second processing block 20, the support substrate S after being cleaned is transferred to the carry-out station 24 and is then carried out of the carry-out station 24.

In addition, the peeling system 1 is provided with a control device 40. The control device 40 is a device configured to control the operation of the peeling system 1. The control device 40 is, for example, a computer, and is provided with a control unit and a memory unit (both not shown). The memory unit stores a program for controlling various kinds of processes such as peeling process. The control unit controls the operation of the peeling system 1 by reading and executing the program stored in the memory unit.

In addition, such a program, which is stored in a computer readable storage medium, may be installed in the memory unit of the control device 40 from the storage medium. The computer readable storage medium includes, for example, a hard disk (HD), a flexible disk (FD), a compact disk (CD), a magneto-optical disk (MO), a memory card and the like.

Next, the operation of the above-described peeling system 1 will be described. First, the first transfer device 31 (see FIG. 1A) disposed in the first transfer region 12 of the first processing block 10 carries the superposed substrate T into the standby station 13, based on the control of the control device 40.

Specifically, the first transfer device 31 allows the substrate holding unit to enter the carry-in/carry-out station 11 and to hold the superposed substrate T accommodated in the cassette Ct and take the superposed substrate T out of the cassette Ct. Here, the superposed substrate T with the target substrate W disposed on the lower side and the support substrate S disposed on the upper side is held by the substrate holding unit of the first transfer device 31 from the top. Then, the first transfer device 31 carries the superposed substrate T taken out from the cassette Ct into the standby station 13.

Next, in the standby station 13, the ID reading device reads the ID of the dicing frame F based on the control of the control device 40. The ID read by the ID reading device is sent to the control device 40.

Subsequently, the first transfer device 31 carries the superposed substrate T out of the standby station 13 and transfers the superposed substrate T to the edge cutting station 14, based on the control of the control device 40. Then, in the edge cutting station 14, the edge cutting device performs the edge cutting processing, based on the control of the control device 40. The edge cutting processing allows the peripheral portion of the adhesive G to be removed, so that in the peeling process to be performed later, the target substrate W and the support substrate S are easily peeled off. Accordingly, the time required for performing the peeling process can be reduced.

In the peeling system 1 according to the first embodiment, since the edge cutting station 14 is incorporated as a part in the first processing block 10, the superposed substrate T carried in the first processing block 10 may be directly carried in the edge cutting station 14 using the first transfer device 31. For this reason, the peeling system 1 makes it possible to improve a throughput of a series of the substrate processing. In addition, since the time from the edge cutting processing to the peeling process can be easily managed, it is possible to stabilize the peeling processing. Also, the peeling system 1 does not necessarily require the provision of the edge cutting station 14.

In addition, for example, when the superposed substrate T is in a processing standby state due to a difference in processing time between devices or the like, the temporary standby section installed in the standby station 13 may be used to allow the superposed substrate T to be in a temporary standby state, thereby reducing the time loss between a series of processes.

Next, based on the control of the control device 40, the first transfer device 31 carries the superposed substrate T after the edge cutting processing out of the edge cutting station 14 and transfers the superposed substrate T to the peeling station 15. Then, in the peeling station 15, the peeling device performs the peeling process based on the control of the control device 40.

Thereafter, in the peeling system 1, the first processing block 10 processes the target substrate W after being peeled, and the second processing block 20 processes the support substrate S after being peeled off. The target substrate W after being peeled is in a state being held by the dicing frame F.

First, in the first processing block 10, based on the control of the control device 40, the first transfer device 31 carries the target substrate W after being peeled out of the peeling device and transfers the target substrate W to the first cleaning station 16.

Then, based on the control of the control device 40, the first cleaning device performs the target substrate cleaning processing to clean the joint surface Wj of the target substrate W after being peeled. The target substrate cleaning processing removes the adhesive G remaining on the joint surface Wj of the target substrate W.

Next, based on the control of the control device 40, the first transfer device 31 performs a target substrate carry-out processing to carry the target substrate W after being cleaned out of the first cleaning device and to transfer the target substrate W to the carry-in/carry-out station 11. Thereafter, the target substrate W is collected after being carried out of the carry-in/carry-out station 11. By doing so, the processing on the target substrate W is terminated.

In the meantime, in the second processing block 20, the third transfer device 33 installed in the delivery station 21 delivers the support substrate S after being peeled off, based on the control of the control device 40. Specifically, the third transfer device 33 receives the support substrate S after being peeled off from the peeling device, and mounts the received support substrate S in the second cleaning device of the second cleaning station 22.

Here, the support substrate S after being peeled off is in a state where the upper surface, i.e., the non-joint surface Sn thereof is held by the peeling device, and the third transfer device 33 holds the joint surface Sj of the support substrate S from the bottom in a contactless manner. In addition, the third transfer device 33 carries the support substrate S held thereby into the second cleaning station 22, reverses the support substrate S upside down, and then, mounts the support substrate S in the second cleaning device. With this configuration, the support substrate S with the joint surface Sj facing upward is mounted in the second cleaning device. In addition, based on the control of the control device 40, the second cleaning device performs the support substrate cleaning processing to clean the joint surface Sj of the support substrate S. The support substrate cleaning processing allows the adhesive G remaining on the joint surface Sj of the support substrate S to be removed.

Next, based on the control of the control device 40, the second transfer device 32 performs a support substrate carry-out processing to carry the support substrate S after being cleaned out of the second cleaning device and to transfer the support substrate S to the carry-out station 24. Thereafter, the support substrate S is collected after being carried out of the carry-out station 24. By doing so, the processing on the support substrate S is terminated.

As described above, the peeling system 1 according to the first embodiment is configured to have front ends for a substrate held by the dicing frame F (the carry-in/carry-out station 11 and the first transfer device 31), and front ends for a substrate not held by the dicing frame F (the carry-out station 24 and the second transfer device 32). With this configuration, since the processing of transferring the target substrate W after being cleaned to the carry-in/carry-out station 11 and the processing of transferring the support substrate S after being cleaned to the carry-out station 24 can be performed in parallel, it is possible to efficiently perform a series of substrate processing processes.

Also, in the peeling system 1 according to the first embodiment, the first processing block 10 and the second processing block 20 are connected through the delivery station 21. With this configuration, since the support substrate S after being peeled off can be directly taken out from the peeling station 15 and can be carried into the second processing block 20, it is possible to transfer the support substrate S after being peeled off to the second cleaning device smoothly.

Therefore, the peeling system 1 according to the first embodiment makes it possible to improve a throughput of a series of the substrate processing.

Here, although the superposed substrate T is carried in a state of being held by the dicing frame F, the present disclosure is not limited thereto. For example, if a mount device configured to attach the dicing frame F to the superposed substrate T is installed in the first processing block 10, a superposed substrate T not attached to the dicing frame F may be carried in, and it may be attached to the dicing frame F within the peeling system 1. In such a case, after moving the edge cutting station 14 to the second processing block 20, the above-described mount device may be installed in the place where the edge cutting station 14 was installed.

### 2. Configuration of Peeling Device

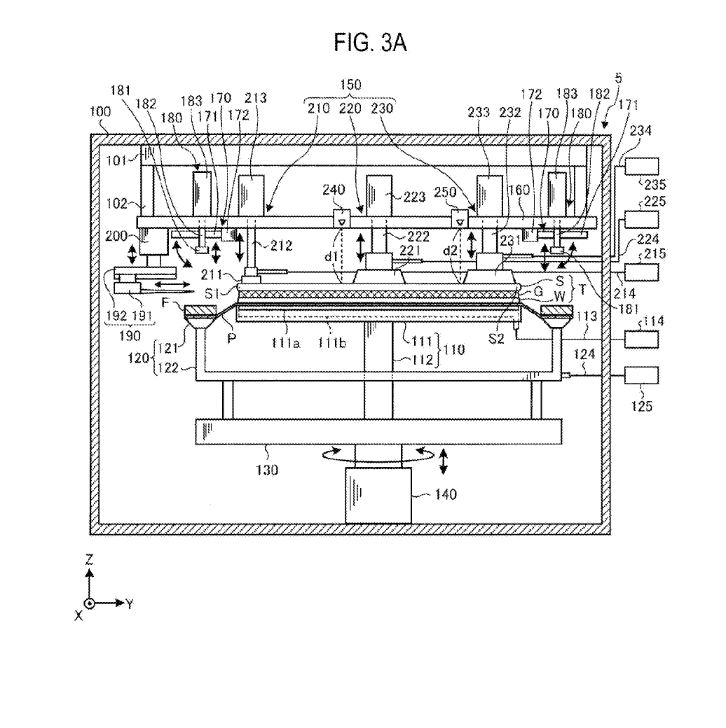

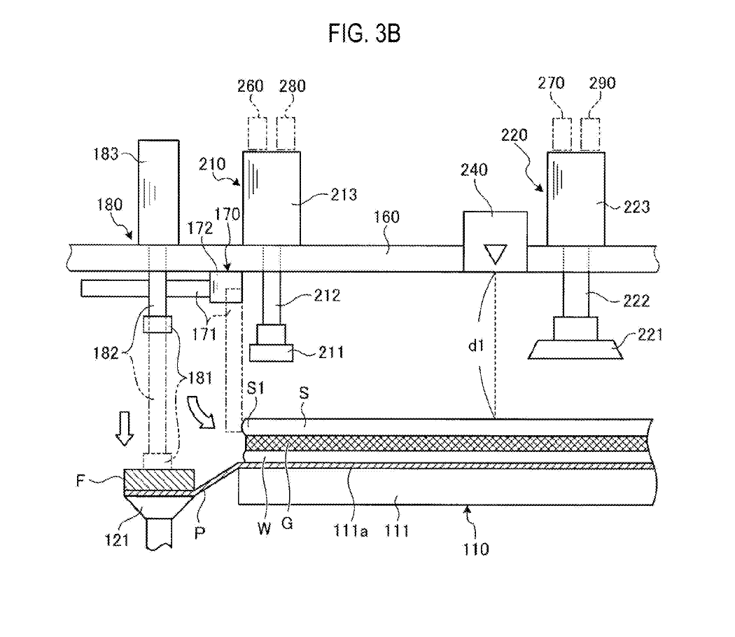

Next, a configuration of the peeling device installed in the peeling station 15 and the peeling operation of the superposed substrate T using the peeling device will be described. FIG. 3A is a schematic side view illustrating the configuration of the peeling device and FIG. 3B is a partially enlarged side view schematically illustrating the configuration of the peeling device shown in FIG. 3A.

As shown in FIG. 3A, a peeling device 5 is provided with a processing unit 100. An inlet/outlet (not shown) is formed in a lateral side of the processing unit 100, and the superposed substrate T is carried into the processing unit 100 through the inlet/outlet, or the target substrate W and the support substrate S after being peeled off are carried out of the processing unit 100 through the inlet/outlet. The inlet/outlet is provided with, for example, an opening/closing shutter, which divides the processing unit 100 from another region and prevents particles from being introduced therethrough. In addition, the inlet/outlet is installed in each of the lateral sides adjacent to the first transfer region 12 and the delivery station 21.

The peeling device 5 includes a first holding unit 110, a frame holding unit 120, a lower base part 130, a rotary lifting unit 140, a second holding unit 150, an upper base part 160, positioning units 170, downward pressing units 180, a peeling inducement unit 190, and a position adjustment unit 200. They are disposed inside the processing unit 100.

The first holding unit 110 holds the target substrate W of the superposed substrate T from the bottom, and the second holding unit 150 holds the support substrate S of the superposed substrate T from the top. In addition, the second holding unit 150 moves the support substrate S held thereby in a direction away from the surface of the target substrate W. Accordingly, the peeling device 5 separates the superposed substrate T into the support substrate S and the target substrate W. Hereinafter, the respective components will be described in detail.

The first holding unit 110 suction-holds the target substrate W of the superposed substrate T through the dicing tape P.

The first holding unit 110 is provided with a disk-shaped main body 111, and a pillar member 112 configured to support the main body 111. The pillar member 112 is supported by the lower base part 130.

The main body 111 is made of, for example, a metal member such as aluminum. A suction surface 111a is installed on the upper surface of the main body 111. The suction surface 111a has a diameter approximately equal to that of the superposed substrate T and is brought into contact with the lower surface of the superposed substrate T, i.e., the non-joint surface Wn of the target substrate W. The suction surface 111a is formed of, for example, a porous body or porous ceramic such as silicon carbide.

A suction space 111b in communication with the outside with the suction surface 111a being interposed is formed inside the main body 111. The suction space 111b is connected to an intake device 114 such as a vacuum pump through an intake pipe 113.

The first holding unit 110 suction-holds the non-joint surface Wn of the target substrate W on the suction surface 111a through the dicing tape P using negative pressure generated by the air intake of the intake device 114. With this configuration, the first holding unit 110 holds the target substrate W. Here, although it has been described that the first holding unit 110 is a porous chuck as an example, the first holding unit may include, for example, an electrostatic chuck or the like.

The frame holding unit 120 configured to hold the dicing frame F from the bottom is disposed radially outside the first holding unit 110. The frame holding unit 120 has a plurality of suction pads 121 configured to suction-hold the dicing frame F, and a support member 122 configured to support the suction pads 121.

The suction pads 121 are made of an elastic member such as rubber, and respectively installed at, for example, positions corresponding to four positions (e.g. front, rear, left and right) on the dicing frame F shown in FIG. 2A. In addition, although the suction pads 121 are installed at four positions as described above, this configuration is for illustrative purposes and not for limitation purposes, and the suction pads 121 may be installed at, for example, three or less positions or five or more positions.

The suction pad 121 is formed with an intake port (not shown), and an intake device 125 such as a vacuum pump is connected to the intake port through the support member 122 and an intake pipe 124. In addition, the intake port of the suction pad 121 is positioned vertically below the suction surface 111a of the first holding unit 110.

The support member 122 is supported by the lower base part 130. The frame holding unit 120 so configured suction-holds the dicing frame F using negative pressure generated by the air intake of the intake device 125. With this configuration, the frame holding unit 120 holds the dicing frame F.

The lower base part 130 is disposed below the first holding unit 110 and the frame holding unit 120 and supports the first holding unit 110 and the frame holding unit 120. The lower base part 130 is supported by the rotary lifting unit 140 fixed to the bottom surface of the processing unit 100.

The rotary lifting unit 140 rotates the lower base part 130 around the vertical axis. Accordingly, the first holding unit 110 and the frame holding unit 120 supported by the lower base part 130 are rotated together. In addition, the rotary lifting unit 140 moves the lower base part 130 in the vertical direction. Accordingly, the first holding unit 110 and the frame holding unit 120 supported by the lower base part 130 are lifted up and down together.

The second holding unit 150 is disposed above the first holding unit 110 so that they face each other. The second holding unit 150 includes a plurality of suction moving units. Specifically, the second holding unit 150 according to the first embodiment includes a first suction moving unit 210, second suction moving units 220, and a third suction moving unit 230. The first to third suction moving units 210, 220 and 230 are supported by the upper base part 160. The upper base part 160 is supported by a fixed member 101, which is fixed to the ceiling of the processing unit 100, through pillars 102.

The first suction moving unit 210 suction-holds a peripheral portion of the support substrate S adjacent to one end S1 thereof. In addition, the second suction moving units 220 suction-hold a region in the vicinity of the central portion of the support substrate S rather than the peripheral portion of the support substrate S. The second suction moving units 220 are arranged and disposed at a plurality of positions, for example, two positions in the X axis direction as described later, and one position on the back side of the paper which is not shown in FIGS. 3A and 3B.

In addition, the third suction moving unit 230 suction-holds a peripheral portion of the support substrate S adjacent to the other end S2 thereof. The first to third suction moving units 210, 220 and 230 each independently move the regions suction-held thereby in directions away from the surface of the target substrate W.

The first suction moving unit 210 includes a suction pad 211, a pillar member 212, and a moving mechanism 213. In addition, each of the second suction moving units 220 includes a suction pad 221, a pillar member 222, and a moving mechanism 223. In the same way, the third suction moving unit 230 also includes a suction pad 231, a pillar member 232, and a moving mechanism 233.

The suction pads 211, 221 and 231 each are formed of an elastic member such as rubber. The suction pads 211, 221 and 231 are respectively formed with intake ports (not shown), and intake devices 215, 225 and 235 such as vacuum pumps are connected to the intake ports through intake pipes 214, 224 and 234, respectively.

The pillar members 212, 222 and 232 support the suction pads 211, 221 and 231 at distal ends of the pillar members, respectively. Proximal ends of the pillar members 212, 222 and 232 are supported by the moving mechanisms 213, 223 and 233, respectively. The moving mechanisms 213, 223 and 233 are fixed at the upper portion of the upper base part 160 and respectively move the pillar members 212, 222 and 232 in the vertical direction.

The first to third suction moving units 210, 220 and 230 suction-hold the support substrate S using negative pressure generated by the air intake of the intake devices 215, 225 and 235. With this configuration, the first to third suction moving units 210, 220 and 230 hold the support substrate S.

Also, in a state where the first to third suction moving units 210, 220 and 230 hold the support substrate S, the moving mechanisms 213, 223 and 233 respectively move the pillar members 212, 222 and 232 and the suction pads 211, 221 and 231 along the vertical direction. With this configuration, the support substrate S is moved along the vertical direction.

The peeling device 5 first operates the moving mechanism 213, then operates the moving mechanisms 223, and finally operates the moving mechanism 233. That is, the peeling device 5 pulls the support substrate S in such a manner that the peripheral portion thereof adjacent to the one end S1 is first pulled, the central portion is then pulled, and the peripheral portion adjacent to the other end S2 is finally pulled. Accordingly, the peeling device 5 peels off the support substrate S from the target substrate W gradually and continuously from the one end S1 to the other end S2. Such operation will be specifically described later.

The positioning units 170 are disposed above the first holding unit 110. The positioning units 170 positions the superposed substrate T, which is transferred to the peeling station 15 by the first transfer device 31 and mounted on the first holding unit 110, to a defined position (for example, a position coincides with the position of the suction surface 111a), i.e., centers the superposed substrate T.

The positioning units 170 are respectively installed at, for example, front, rear, left and right four corresponding places of the outer peripheral portion of the superposed substrate T shown in FIG. 2A. In addition, the number of places at which the positioning units 170 are installed is not limited to four as described above, and the positioning units 170 may be installed at, for example, front and rear or left and right two places of the outer peripheral portion of the superposed substrate T, three places spaced apart from one another at an interval of 120 degrees about the center of the superposed substrate T, or five or more places.

As well shown in FIG. 3B, each of the positioning units 170 includes an arm portion 171 and a rotary moving mechanism 172. The arm portion 171 is an elongated member, and its proximal end is rotatably connected to the rotary moving mechanism 172. In addition, the length of the arm portion 171 is set to a value such that, for example, its distal end comes into contact with the lateral side of the superposed substrate T when the arm portion 171 is rotated by the rotary moving mechanism 172 until the distal end is directed vertically downward.

The rotary moving mechanism 172 is fixed to, for example, a lower portion of the upper base part 160, and the arm portion 171 is rotated about the proximal end thereof. If the arm portions 171 of the positioning units 170 are respectively rotated by the rotary moving mechanisms 172, as shown with an imaginary line in FIG. 3B, the distal ends of the arm portions 171 come into contact with the lateral side of the superposed substrate T. Accordingly, the superposed substrate T is positioned to the defined position. As described above, even if the superposed substrate T is mounted on the first holding unit 110 in a state of being offset from the defined position, the provision of the positioning units 170 allows the superposed substrate T to be moved and corrected to the proper position on the first holding unit 110, specifically the position at which for example, the superposed substrate T coincides with the suction surface 111a.

The downward pressing units 180 are disposed over the suction pads 121 of the frame holding unit 120, respectively. That is, the downward pressing units 180 are respectively disposed at positions corresponding to the suction pads 121, specifically the positions corresponding to the front, rear, left and right places of the dicing frame F, for example, shown in FIG. 2A. In addition, although it has been described above that the downward pressing units 180 are installed at the same four places as the suction pads 121, this configuration is for illustrative purposes and may be modified according to the number of the suction pads 121.

The above-described downward pressing units 180 push the dicing frame F vertically downward, thereby allowing the suction pads 121 to suction-hold the dicing frame F. Specifically, as described above, the intake ports of the suction pads 121 are positioned vertically below the suction surface 111a of the first holding unit 110. Accordingly, when the superposed substrate T transferred to the peeling station 15 by the first transfer device 31 is mounted on the suction surface 111a of the first holding unit 110, a gap is generated between the dicing frame F and the suction pads 121 as much as the amount by which the suction pads 121 is lowered. Therefore, the downward pressing units 180 pushes the dicing frame F down toward the suction pads 121 and thus the dicing frame F is suction-held by the suction pads 121.

Specifically, as well shown in FIG. 3B, each of the downward pressing units 180 includes a pressing pad 181, a pillar member 182, and a moving mechanism 183.

The pressing pad 181 is formed of an elastic member such as rubber. The pressing pad 181 is connected to a distal end of the pillar member 182. A proximal end of the pillar member 182 is supported by the moving mechanism 183. The moving mechanism 183 is fixed to an upper portion of the upper base part 160 and moves the pillar member 182 in the vertical direction.

The moving mechanism 183 of the downward pressing unit 180 moves the pillar member 182 and the pressing pad 181 along the vertical direction. Therefore, for example, if the moving mechanism 183 moves the pillar member 182 and the pressing pad 181 vertically downward, the pressing pad 181 comes into contact with the dicing frame F and then presses and moves the dicing frame F as shown by an imaginary line in FIG. 3B. Accordingly, the dicing frame F moves vertically downward and is suction-held by the suction pads 121.

With this configuration, a space into which the peeling inducement unit 190 described later may burrow, is formed in a lateral side of the superposed substrate T. Accordingly, it is possible to allow a sharp member (described later) of the peeling inducement unit 190 to easily approach and make contact with the lateral side of the superposed substrate T, specifically the lateral side of the support substrate S in the vicinity of the adhesive G.

As shown in FIG. 3A, the peeling inducement unit 190 is disposed outside the second holding unit 150. The peeling inducement unit 190 forms a region at which the peeling off the support substrate S from the target substrate W is initiated, in the lateral side of the superposed substrate T adjacent to the one end S1.

The peeling inducement unit 190 includes a sharp member 191 and a moving mechanism 192. The sharp member 191 may be, for example, a blade that is supported by the moving mechanism 192 so that a distal end of the sharp member 191 protrudes toward the superposed substrate T. In addition, examples of the sharp member 191 may include, for example, a razor blade, a roller blade, an ultrasonic cutter, and the like.

The moving mechanism 192 moves the sharp member 191 along a rail extending in the Y axis direction. In the peeling device 5, the sharp member 191 is moved by the moving mechanism 192, and is brought into contact with the lateral side of the support substrate S in the vicinity of the adhesive G. With this configuration, the peeling device 5 forms the region (hereinafter, referred to as “peeling initiation region”), at which the peeling off the support substrate S from the target substrate W is initiated, in the lateral side of the superposed substrate T adjacent to the one end S1.

In addition, the moving mechanism 192 is supported by the position adjustment unit 200 from the top. The position adjustment unit 200 is fixed to, for example, the lower portion of the upper base part 160 to move the moving mechanism 192 along the vertical direction. With this configuration, it is possible to adjust a height position of the sharp member 191, i.e., a contact position thereof with the lateral side of the superposed substrate T.

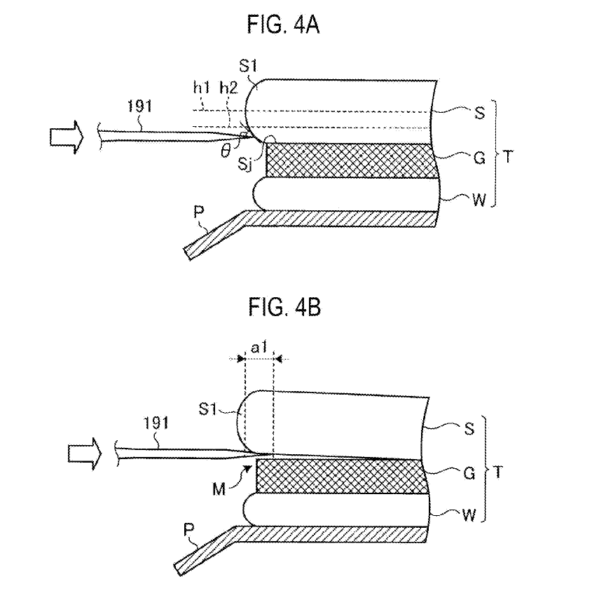

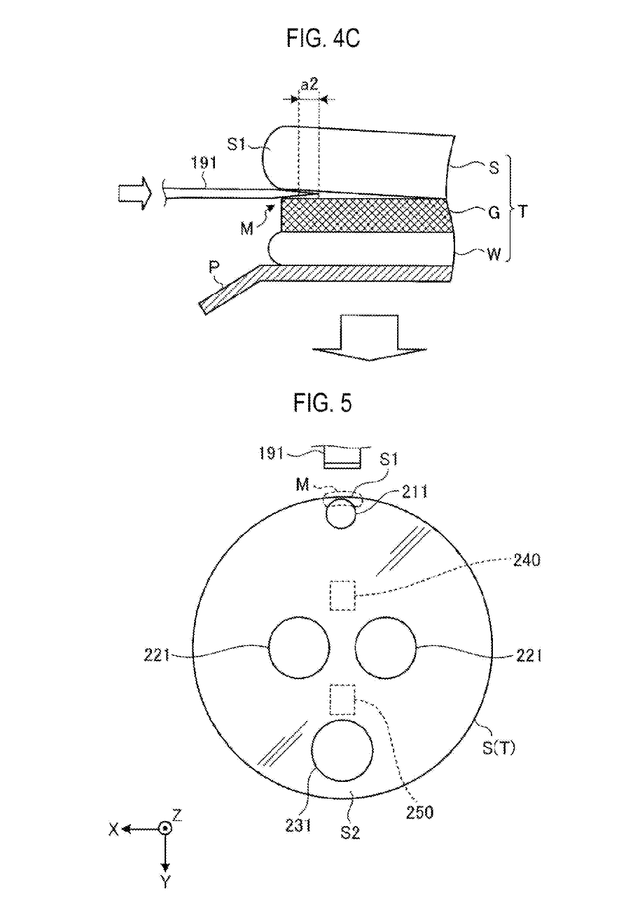

Here, the peeling inducement processing performed using the peeling inducement unit 190 will be described in detail with reference to FIGS. 4A to 4C. FIGS. 4A to 4C are explanatory views illustrating the operation of the peeling inducement processing.

In addition, the peeling inducement processing is performed after the target substrate W of the superposed substrate T is held by the first holding unit 110 (see FIG. 3A) and the dicing frame F is held by the frame holding unit 120, and before the support substrate S is held by the second holding unit 150. That is, the peeling inducement processing is performed in a state where the support substrate S is free. In addition, the peeling device 5 performs the peeling inducement processing shown in FIGS. 4A to 4C based on the control of the control device 40.

In the peeling device 5, the position adjustment unit 200 is used to adjust the height position of the sharp member 191, and then, the moving mechanism 192 (see FIG. 3A) is used to move the sharp member 191 toward the lateral side of the superposed substrate T. Specifically, as shown in FIG. 4A, the sharp member 191 is moved approximately horizontally toward the lateral side of the support substrate S in the vicinity of the adhesive G of the lateral side of the superposed substrate T adjacent to the one end S1.

“The lateral side of the support substrate S in the vicinity of the adhesive G” refers to a lateral side of the support substrate S in the vicinity of the joint surface Sj rather than a half thickness position h1 of the support substrate S. That is, the lateral side of the support substrate S is formed in a shape of an approximately circular arc, and “the lateral side of the support substrate S in the vicinity of the adhesive G” is a lateral side forming an angle θ with the sharp member 191 that ranges from 0 degrees to less than 90 degrees when an angle between the sharp member 191 and the joint surface Sj is defined as 0 degrees.

The peeling device 5 first advances the sharp member 191 up to a predetermined position (preliminary advance). Thereafter, the peeling device 5 further advances the sharp member 191 to bring the sharp member 191 into contact with the lateral side of the support substrate S in the vicinity of the adhesive G. In addition, the peeling inducement unit 190 is provided with, for example, a load cell (not shown), and the peeling device 5 detects a load applied to the sharp member 191 using the load cell, thereby detecting whether the sharp member 191 is in contact with the support substrate S.

As described above, the lateral side of the support substrate S is formed in the shape of an approximately circular arc. Therefore, as the sharp member 191 is into contact with the lateral side of the support substrate S in the vicinity of the adhesive G, an upward force is exerted to the support substrate S.

Next, as shown in FIG. 4B, the peeling device 5 further advances the sharp member 191. Accordingly, the support substrate S is pushed upward along the curvature of the lateral side. As a result, a portion of the support substrate S is peeled off from the adhesive G to form a peeling initiation region M.

In addition, since the support substrate S is not held by the second holding unit 150 and is in a free state, the support substrate S is not hindered from moving upward. In this processing, a distance a1 by which the sharp member 191 is advanced is, for example, 2 mm or so.

Also, the peeling device 5 may be configured to include a confirmation device (not shown) configured to confirm a peeled-off state of the support substrate S by the above processing, specifically a confirmation device configured to confirm whether the peeling initiation region M is formed. Specifically, the confirmation device includes, for example, an infrared (IR) camera (not shown) installed above the support substrate S.

In detail, a reflectance of an infrared ray at a region of the support substrate S peeled off from the target substrate W is different from that at a region of the support substrate S not peeled off. Therefore, as the IR camera first captures an image of the support substrate S, an image data representing a difference in infrared reflectance or the like in the support substrate S is acquired. Then, the image data is transmitted to the control device 40, and the control device 40 may detect the region of the support substrate S peeled off from the target substrate W, i.e., the peeling initiation region M, based on the image data.

When the control device 40 detects the peeling initiation region M, the peeling device 5 performs the subsequent processing described later. In the meantime, when the control device 40 does not detect the peeling initiation region M, the peeling device 5 forms the peeling initiation region M, for example, by further advancing the sharp member 191, or by first retracting the sharp member 191 to be separated from the support substrate S and then performing the operations shown in FIGS. 4A and 4B again. As described above, as the confirmation device configured to confirm a peeled-off state of the support substrate S is installed and the peeling device 5 is operated according to the peeled-off state, the peeling initiation region M may be well formed.

If the peeling initiation region M is formed, then, as shown in FIG. 4C, the peeling device 5 lowers the first holding unit 110 using the rotary lifting unit 140 (see FIG. 3A) and further advances the sharp member 191. Accordingly, a downward force is applied to the target substrate W and the adhesive G, and an upward force is applied to the support substrate S supported by the sharp member 191. With this configuration, the peeling initiation region M is enlarged.

In this processing, a distance a2, by which the sharp member 191 is advanced, is, for example, 1 mm or so.

As the sharp member 191 is brought into contact with the lateral side of the support substrate S in the vicinity of the adhesive G as described above, the peeling device 5 can form the peeling initiation region M, which triggers the peeling off of the support substrate S from the target substrate W, in the lateral side of the superposed substrate T.

The support substrate S has a thickness about 5 to 15 times larger than that of the adhesive G. Therefore, as compared with a case where a peeling initiation region is formed by bringing the sharp member 191 into contact with the adhesive G, it is easy to control the position of the sharp member 191 in the vertical direction.

In addition, as the sharp member 191 is brought into contact with the lateral side of the support substrate S in the vicinity of the adhesive G, a force (i.e., an upward force) can be applied to the support substrate S in a direction in which the support substrate S is peeled off from the target substrate W. Further, since a region close to the outermost peripheral portion of the support substrate S is lifted up, the force in the direction in which the support substrate S is peeled off from the target substrate W can be efficiently applied to the support substrate S.

In addition, as compared with a case where the sharp member 191 is brought into contact with the adhesive G, it is possible to reduce the possibility that the sharp member 191 is brought into contact with the target substrate W.

More specifically, “the lateral side of the support substrate S in the vicinity of the adhesive G” is a lateral side of the support substrate S ranging from the joint surface Sj of the support substrate S to a quarter thickness position h2 of the support substrate S, as shown in FIG. 4A, i.e., a lateral side that forms the angle θ with the sharp member 191 ranging from not less than 0 degree to not more than 45 degrees. This is because the smaller the angle θ between the lateral side and the sharp member 191 is, the larger the force lifting the support substrate S up is.

In addition, when the adhesive strength between the support substrate S and the adhesive G is relatively weak, a simple abutment of the sharp member 191 to the lateral side of the support substrate S in the vicinity of the adhesive G, as shown in FIG. 4A, may form the peeling initiation region M. In such a case, the operations shown in FIGS. 4B and 4C can be omitted in the peeling device 5.

When the adhesive strength between the support substrate S and the adhesive G is relatively strong, for example, the peeling device 5 may further rotate the rotary lifting unit 140 from the state shown in FIG. 4C and may rotate the first holding unit 110 and the frame holding unit 120 around the vertical axis, for example, 360 degrees. Accordingly, the peeling initiation region M can be formed over the entire circumference of the joint surface Sj of the support substrate S, so that the support substrate S can be easily peeled off from the target substrate W.

Next, the arrangement of the first to third suction moving units 210, 220 and 230 and the like will be described with reference to FIG. 5. FIG. 5 is a schematic plan view showing a positional relationship between the support substrate S, the suction pad 211 of the first suction moving unit 210, the suction pads 221 of the second suction moving units 220 and the suction pad 231 of the third suction moving unit 230.

As shown in FIG. 5, the suction pad 211 of the first suction moving unit 210 suction-holds the peripheral portion of the support substrate S adjacent to the one end S1 corresponding to the peeling initiation region M. In addition, the second suction moving units 220 are arranged and disposed at a plurality of places along the direction (i.e., the X axis direction) intersecting the direction (i.e., the Y axis direction) from the one end S1 of the support substrate S toward the other end S2 thereof. The suction pads 221 of the second suction moving units 220 suction-hold a region between the one end S1 and the other end S2 of the support substrate S, specifically, a region in the vicinity of the center of the support substrate S rather than the peripheral portion thereof adjacent to the one end S1. In addition, the suction pad 231 of the third suction moving unit 230 suction-holds the peripheral portion of the support substrate S adjacent to the other end S2.

The suction pads 221 and 231 are formed to have substantially the same suction area, while the suction pad 211 is formed to have a suction area smaller than those of the suction pads 221 and 231. This is because the smaller suction pad 211 makes it possible to suction-hold and raise only the peripheral portion of the support substrate S corresponding to the peeling initiation region M. Therefore, it is possible to prevent deterioration of a peeling force caused by suction-holding and raising even the peripheral portion in which the peeling initiation region M is not formed.

In addition, in some embodiments, the suction pad 211 may be formed smaller than a blade width of the sharp member 191 in the X axis direction, for example. Accordingly, it is possible to ensure that the suction pad 211 is prevented from suction-holding the peripheral portion of the support substrate S in which the peeling initiation region M is not formed. In other words, it is possible to accurately suction-hold only the peripheral portion of the support substrate S in which the peeling initiation region M is formed. In addition, the suction pads 221 and 231 each are formed to be larger than the blade width of the sharp member 191 in the X axis direction.

As shown in FIG. 5, the suction pads 211, 221 and 231 are disposed along the moving direction of the sharp member 191 (the Y axis direction). The peeling device 5 first pulls the suction pad 211 up prior to the suction pads 221 and 231, and then pulls the suction pads 221 up prior to the suction pad 231. That is, the peripheral portion of the support substrate S adjacent to the one end S1 is first raised, and the suction pads 221 and 231 are raised in this order. Accordingly, the peeling device 5 peels off the support substrate S from the target substrate W gradually and continuously from the one end S1 toward the other end S2 via the vicinity of the central portion.

As described above, the support substrate S is peeled off from the target substrate W gradually from the one end S1 toward the other end S2. However, for example, when the region of the support substrate S which is suction-held by the second suction moving units 220 is not peeled off from the target substrate W yet, if the second suction moving units 220 suction-hold and move the support substrate S in a direction in which the support substrate S is pulled up, an excessive load is applied to the second suction moving units 220, which, for example, may cause the suction pads 221 to be separated from the support substrate S. In addition, the same is true of the third suction moving unit 230 when the region of the support substrate S suction-held by the third suction moving unit 230 is not peeled off from the target substrate W.

Therefore, the peeling device 5 according to the first embodiment is provided with state detection units configured to detect a peeled-off state of the support substrate S from the target substrate W. The control device 40 controls operation timings of the second and third suction moving units 220 and 230 so that the support substrate S is peeled off from the target substrate W gradually from the one end S1 toward the other end S2, based on the peeled-off state detected by the state detection units.

With this configuration, the operations of suction-holding the support substrate S by the second and third suction moving units 220 and 230 and moving the support substrate S in the direction away from the surface of the target substrate W can be performed at appropriate timings. Therefore, it is possible to prevent an excessive load from being applied to the second and third suction moving units 220 and 230.

Here, the state detection units will be described in detail. The state detection units according to the first embodiment are measurement units 240 and 250, which, for example, are installed at the upper base part 160 to measure distances d1 and d2 from a predetermined measurement reference position to the support substrate S, as shown in FIG. 3A. The measurement units 240 and 250 may include, e.g., laser displacement meters. Also, portions of the support substrate S corresponding to the positions in which the measurement units 240 and 250 are disposed are represented by broken lines in FIG. 5.

Although it has been described as an example that the measurement units 240 and 250 include laser displacement meters, the present disclosure is not limited thereto. For example, anything is possible as long as the distances d1 and d2 from the predetermined measurement reference position to the support substrate S can be measured, such as capacitance sensors.

As shown in FIGS. 3B and 5, the measurement unit 240 is disposed in the vicinity of the second suction moving units 220 between the first suction moving unit 210 and the second suction moving units 220. Specifically, the measurement unit 240 is installed close to a position above the region of the support substrate S suction-held by the suction pads 221 of the second suction moving units 220.

As shown in FIGS. 3A and 5, the measurement unit 250 is disposed in the vicinity of the third suction moving unit 230 between the second suction moving units 220 and the third suction moving unit 230. Specifically, the measurement unit 250 is installed close to a position above the region of the support substrate S suction-held by the suction pad 231 of the third suction moving unit 230. The measurement results from the measurement units 240 and 250 are transmitted to the control device 40.

The control device 40 determines whether or not the region of the support substrate S suction-held by the second suction moving units 220 or the third suction moving unit 230 has been peeled off from the target substrate W, based on the measurement results of the measurement units 240 and 250.

Specifically, when after the first suction moving unit 210 moves the support substrate S in the direction away from the target substrate W, the distance d1 measured by the measurement unit 240 is equal to or larger than a threshold value D1, the control device 40 determines that the region of the support substrate S suction-held by the second suction moving units 220 is not peeled off from the target substrate W yet. In addition, when the peeling off of the support substrate S progresses and the distance d1 is less than the threshold value D1, the control device 40 determines that the support substrate S has been peeled off up to a predetermined position between the peripheral portion adjacent to the one end S1 and the region in the vicinity of the central portion. Accurately, the control device 40 determines that the region of the support substrate S suction-held by the second suction moving units 220 has been peeled off from the target substrate W. The threshold value D1 corresponds to the distance d1 when the region of the support substrate S suction-held by the second suction moving units 220 is peeled off from the target substrate W.

Then, when the control device 40 determines that the above-described region has been peeled off form the target substrate W, the control device 40 operates the second suction moving units 220 suction-holding the region to suction-hold the support substrate S and to move the support substrate S in the direction away from the surface of the target substrate W. Accordingly, it is possible to prevent an excessive load from being applied to the second suction moving units 220.

In the same way, after the second suction moving units 220 move the support substrate S in the direction away from the target substrate W, the distance d2 measured by the measurement unit 250 is equal to or larger than a threshold value D2, the control device 40 determines that the region of the support substrate S suction-held by the third suction moving unit 230 is not yet peeled off from the target substrate W. Then, when the peeling off of the support substrate S progresses and the distance d2 is less than the threshold value D2, the control device 40 determines that the support substrate S has been peeled off up to a predetermined position between the region in the vicinity of the central portion and the peripheral portion adjacent to the other end S2. Accurately, the control device 40 determines that the region of the support substrate S suction-held by the third suction moving unit 230 has been peeled off from the target substrate W. The threshold value D2 corresponds to the distance d2 when the region of the support substrate S suction-held by the third suction moving unit 230 is peeled off from the target substrate W.

Then, if it is determined that the region suction-held by the third suction moving unit 230 has been peeled off from the target substrate W, the control device 40 operates the third suction moving unit 230 suction-holding the region to move the support substrate S in the direction away from the surface of the target substrate W. Accordingly, it is possible to prevent an excessive load from being applied to the third suction moving unit 230.

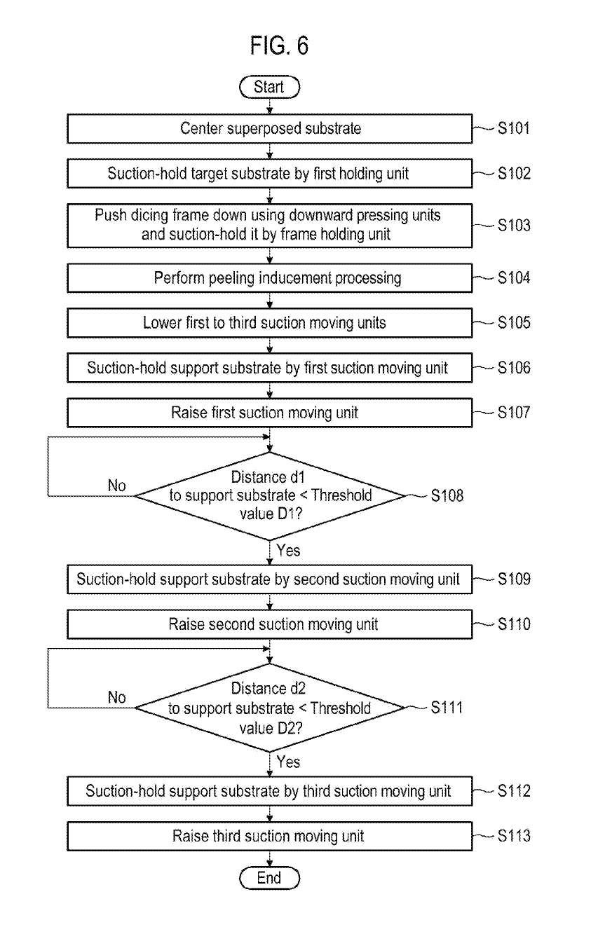

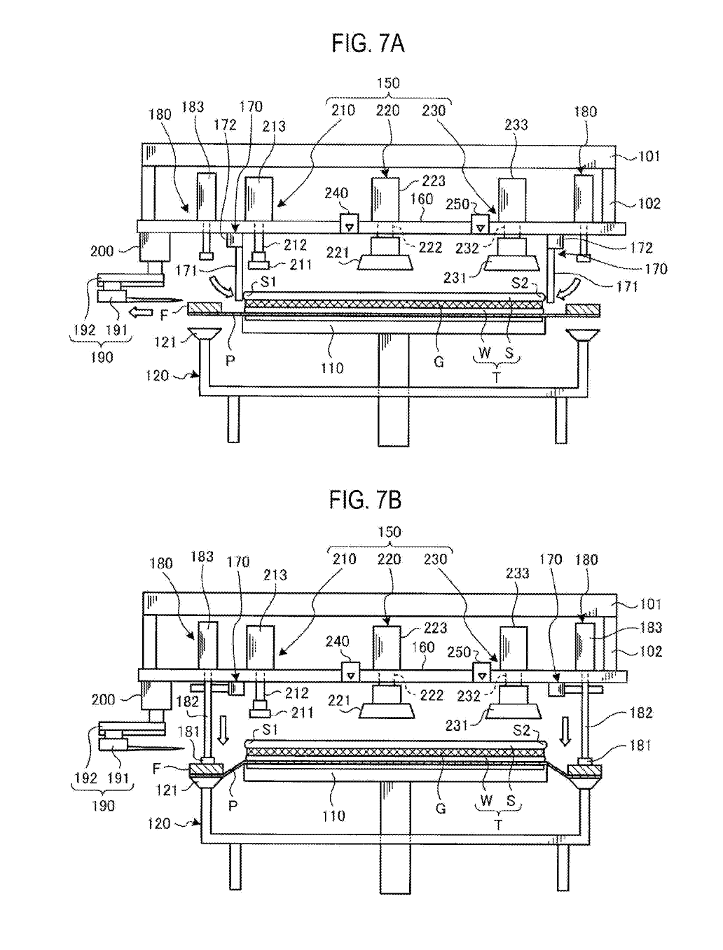

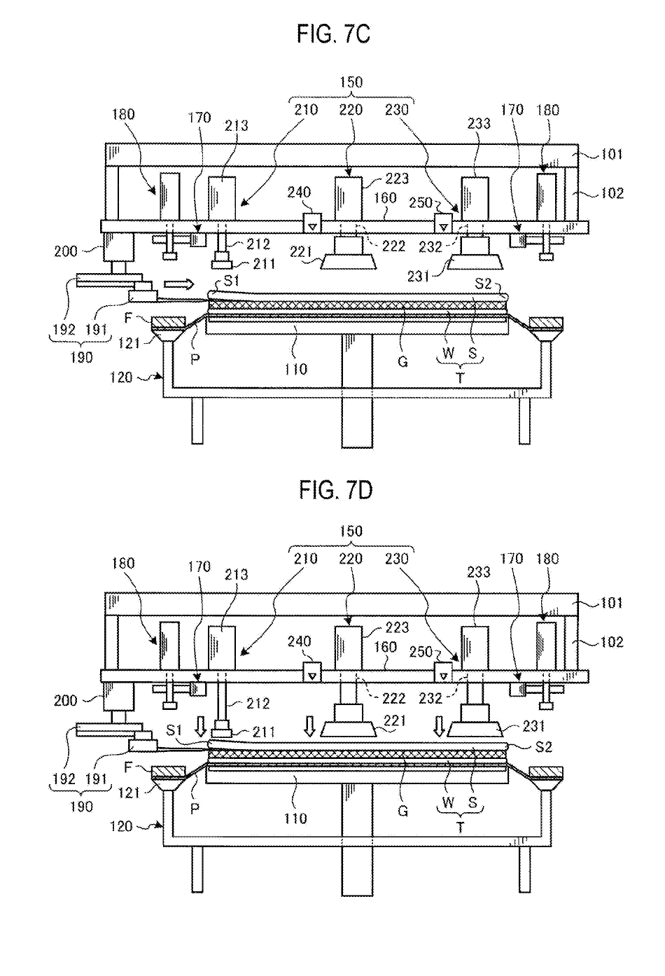

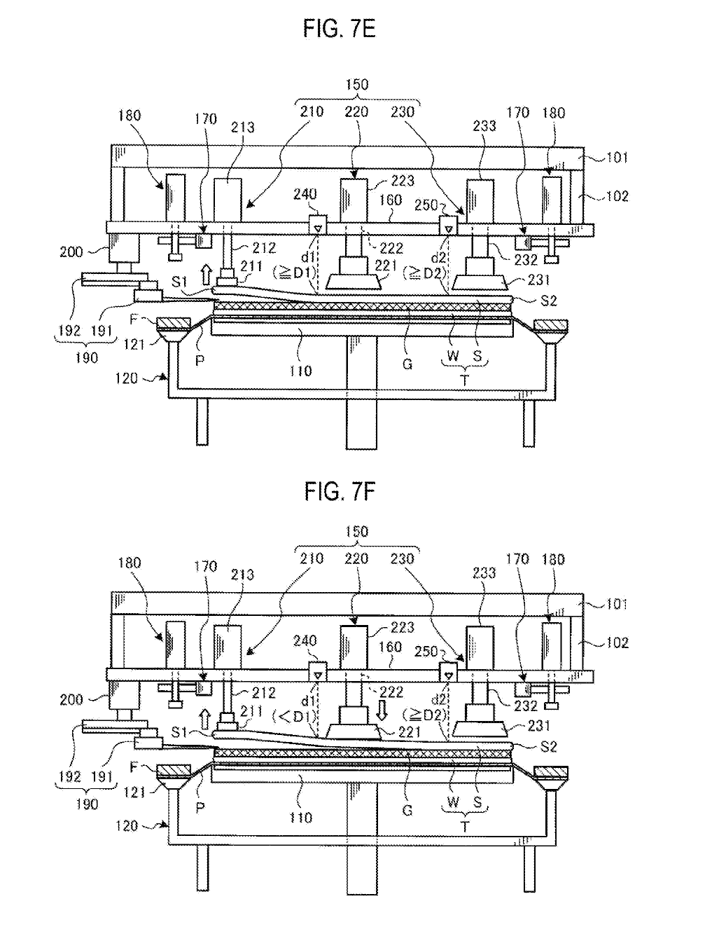

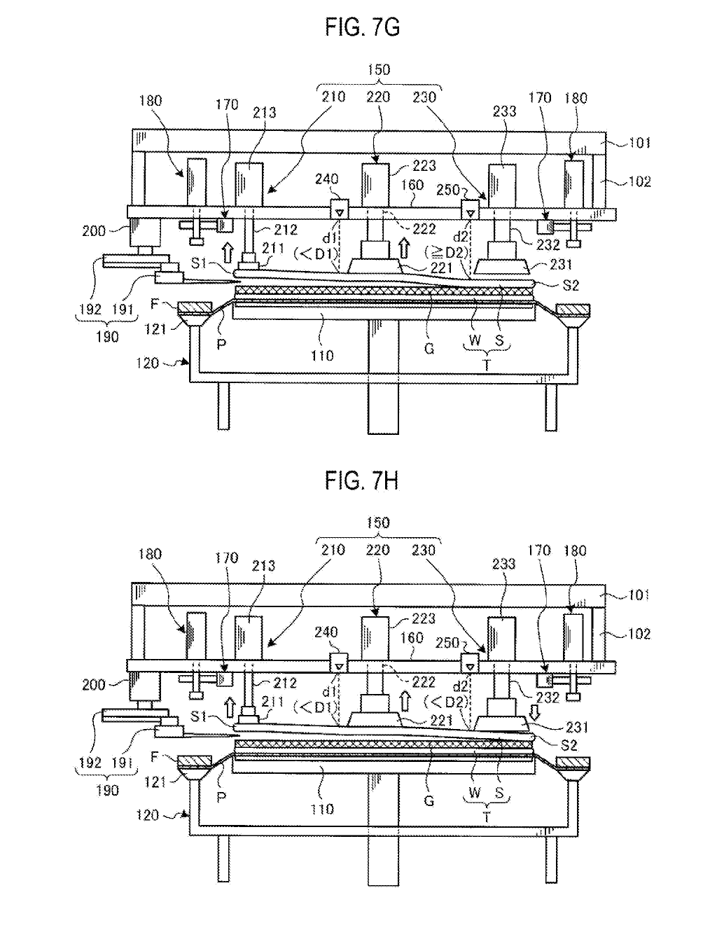

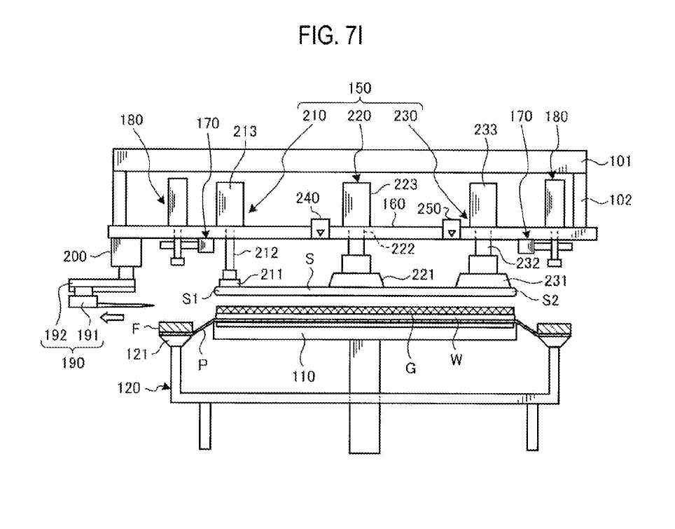

The details of the above-described peeling operation will be described with reference to FIGS. 6 and 7A to 7I. FIG. 6 is a flowchart illustrating processing sequences of the peeling process. In addition, FIGS. 7A to 7I are explanatory views of the peeling operation by the peeling device 5. In addition, the peeling device 5 performs the respective processing sequences shown in FIG. 6, based on the control of the control device 40.

First, in the peeling device 5, the superposed substrate T, which is carried into the peeling station 15 by the first transfer device 31 and mounted on the first holding unit 110, is centered by the positioning units 170 (Step S101). Accordingly, the superposed substrate T is positioned to the defined position of the first holding unit 110 (see FIG. 7A).

Next, the peeling device 5 uses the first holding unit 110 to suction-hold the target substrate W through the dicing tape P (Step S102). Accordingly, the target substrate W of the superposed substrate T is supported by the first holding unit 110.

Next, the peeling device 5 uses the downward pressing units 180 to push the dicing frame F vertically downward and to allow the dicing frame F to be suction-held by the frame holding unit 120 (Step S103). Therefore, the space, which the peeling inducement unit 190 may burrow, is formed in the lateral side of the superposed substrate T (see FIG. 7B).

Thereafter, the peeling device 5 performs the peeling inducement processing described with reference to FIGS. 4A to 4C while allowing the peeling inducement unit 190 to invade the above-described space (Step S104). Accordingly, the peeling initiation region M (see FIG. 4B) is formed at the lateral side of the superposed substrate T adjacent to the one end S1 (see FIG. 7C).

As described above, for example, when the adhesive strength between the support substrate S and the adhesive G is relatively strong, the peeling device 5 may further rotate the rotary lifting unit 140 and may allow the first holding unit 110 and the frame holding unit 120 to rotate around the vertical axis, for example, 360 degrees, in the processing of Step S104. Thus, the peeling initiation region M is formed over the entire circumference of the joint surface Sj of the support substrate S, so that the support substrate S can be easily peeled off from the target substrate W.

Next, the peeling device 5 lowers the suction pads 211, 221 and 231 of the first to third suction moving units 210, 220 and 230 to the vicinity of the support substrate S (Step S105) (see FIG. 7D).

Thereafter, the peeling device 5 uses the first suction moving unit 210 to suction-hold the non-joint surface Sn of the support substrate S (Step S106). As described above, the first suction moving unit 210 suction-holds the peripheral portion of the support substrate S adjacent to the one end S1 corresponding to the peeling initiation region M.

Next, the peeling device 5 raises the suction pad 211 of the first suction moving unit 210 (Step S 107). That is, the peeling device 5 pulls the peripheral portion of the support substrate S adjacent to the one end S1 corresponding to the peeling initiation region M. Accordingly, the support substrate S begins to be peeled off from the target substrate W continuously from its peripheral portion toward the central portion (see FIG. 7E).

Then, the peeling device 5 determines whether or not the distance d1 from the predetermined measurement reference position to the support substrate S measured by the measurement unit 240 is less than the threshold value D1 (Step S 108). If the distance d1 is equal to or larger than the threshold value D1 (Step S 108, “No”), it is determined that the region of the support substrate S suction-held by the second suction moving units 220 is not peeled off from the target substrate W yet, and the processing of Step S108 is repeated.

In the meantime, when the distance d1 is less than the threshold value D1 (Step S108, “Yes”), it is determined that the region of the support substrate S suction-held by the second suction moving units 220 has been peeled off from the target substrate W. Then, the peeling device 5 lowers the second suction moving units 220 and uses the second suction moving units 220 to suction-hold the non-joint surface Sn of the support substrate S (Step S109). As described above, the second suction moving units 220 suction-hold the region in the vicinity of the central region rather than the peripheral portion of the support substrate S adjacent to the one end S1 (see FIG. 7F).

Thereafter, the peeling device 5 raises the suction pads 221 of the second suction moving units 220 (Step S110). That is, the peeling device 5 additionally pulls the vicinity of the central portion of the support substrate S while pulling the peripheral portion of the support substrate S adjacent to the one end S1 (see FIG. 7G).

Next, the peeling device 5 determines whether the distance d2 from the predetermined measurement reference position to the support substrate S measured by the measurement unit 250 is less than the threshold value D2 (Step S111). When the distance d2 is equal to or larger than the threshold value D2 (Step S111, “No”), it is determined that the region of the support substrate S suction-held by the third suction moving unit 230 is not peeled off from the target substrate W yet, and then, the processing of Step S111 is repeated.

In the meantime, when the distance d2 is less than the threshold value D2 (Step S111, “Yes”), it is determined that the region of the support substrate S suction-held by the third suction moving unit 230 has been peeled off from the target substrate W. Then, the peeling device 5 lowers the third suction moving unit 230 and uses the third suction moving unit 230 to suction-hold the non-joint surface Sn of the support substrate S (Step S112). As described above, the third suction moving unit 230 suction-holds the peripheral portion of the support substrate S adjacent to the other end S2 (see FIG. 7H).

Thereafter, the peeling device 5 raises the suction pad 231 of the third suction moving unit 230 (Step S 113). That is, the peeling device 5 further pulls the peripheral portion of the support substrate S adjacent to the other end S2 while pulling the peripheral portion of the support substrate S adjacent to the one end S1 and the vicinity of the central portion of the support substrate S. Thus, the support substrate S is peeled off from the target substrate W.

Thereafter, the peeling device 5 raises only the second and third suction moving units 220 and 230 or lowers only the first and second suction moving units 210 and 220 to make the support substrate S horizontal, and retracts the sharp member 191 to terminate the peeling process (see FIG. 7I).

As described above, in the peeling device 5 according to the first embodiment, after the first suction moving unit 210 moves the peripheral portion of the support substrate S in the direction away from the surface of the target substrate W, the second and third suction moving units 220 and 230 are allowed to move the central portion or the other end S2 of the support substrate S in the direction away from the surface of the target substrate W.

With this configuration, without applying a large load to the support substrate S, the superposed substrate T can be separated into the support substrate S and the target substrate W.

For example, if peeling of the superposed substrate is performed by exerting a tensile force on one side of a peripheral portion of the superposed substrate with the other side of the peripheral portion serving as a fulcrum, as described in Japanese Patent Publication No. 2007-526628, there is a problem in that a support substrate is largely bent as the peeling process progresses. On the contrary, according to the peeling device 5, while preventing the support substrate S from being deformed, the support substrate S can be peeled off by performing the peeling operation using the first suction moving unit 210 suction-holding the peripheral portion of the support substrate S and the second suction moving units 220 suction-holding the central portion of the support substrate S.

Also, in the peeling device 5 according to the first embodiment, based on the peeled-off state detected by the state detection units, the operation timings of the second and third suction moving units 220 and 230 are controlled. With this configuration, for example, when the region of the support substrate S suction-held by the second suction moving units 220 is not peeled off from the target substrate W yet, it is possible to prevent the second suction moving units 220 from suction-holding and moving the support substrate S in the pull-up direction. Accordingly, since an excessive load to the second suction moving units 220 can be avoided, for example, there is less possibility for the suction pads 221 to depart from the support substrate S.

In addition, after the peeling off of the target substrate W and the support substrate S, the peeling device 5 may rotate the first holding unit 110 and the frame holding unit 120 by using the rotary lifting unit 140. With this configuration, for example, when the adhesive G applied over the support substrate S and the target substrate W remains, it can be removed.

In addition, the peeling device 5 may detect loads applied to the moving mechanisms 213, 223 and 233 during the peeling off of the support substrate S and, based on the detection results, may stop the peeling process shown in FIG. 6. Specifically, in the peeling device 5, for example, load cells (not shown) are installed at the first to third suction moving units 210, 220 and 230, and when the support substrate S is suction-held and peeled off, the loads applied to the moving mechanisms 213, 223 and 233 by the support substrate S are detected, respectively. Then, if at least one of the detected loads of the moving mechanisms 213, 223 or 233 exceeds a threshold value, specifically if at least one of the loads applied to the moving mechanisms 213, 223 or 233 is excessively increased, the peeling device 5 stops the peeling process of FIG. 6 on the way. With this configuration, the first to third suction moving units 210, 220 and 230 do not peel off the support substrate S from the target substrate W with excessive force, and thus, it is possible to prevent the superposed substrate T from being broken or the like, for example.

If the peeling device 5 terminates the peeling process, the third transfer device 33 (see FIG. 1) receives the peeled-off support substrate S from the peeling device 5 and mounts the received support substrate S in the second cleaning device of the second cleaning station 22 (see FIG. 1).

Here, the support substrate S after being peeled off is in a state where the non-joint surface Sn is held by the first suction moving unit 210 and the second suction moving units 220, and the third transfer device 33 holds the joint surface Sj of the support substrate S from the bottom in a contactless manner. As described above, the second holding unit 150 functions as a delivery unit configured to deliver the support substrate S after being peeled off to the third transfer device 33. In the first embodiment, since the second suction moving units 220 suction-holds the vicinity of the central portion of the support substrate S, the support substrate S after being peeled off can be stably held.

In addition, the first transfer device 31 (see FIG. 1) carries the target substrate W after being peeled off out of the peeling device 5 and transfers it to the first cleaning station 16. Here, the target substrate W after being peeled is held by the first holding unit 110 in a state where the joint surface Wj to be cleaned is disposed on the upper side as shown in FIG. 7I. Therefore, the first transfer device 31 can transfer the target substrate W to the first cleaning station 16 as it is, without turning the same over after carrying the target substrate W after being peeled out of the peeling device 5.

As described above, in the peeling device 5, since the first holding unit 110 holds the target substrate W from the bottom and the second holding unit 150 holds the support substrate S of the superposed substrate T from the top, the target substrate W after being peeled need not be flipped upside down, and thus, the peeling process can be efficiently performed.

As described above, the peeling device 5 according to the first embodiment is provided with the first holding unit (holding unit) 110, the plurality of suction moving units 210, 220 and 230, the measurement units (state detection units) 240 and 250, and the control device (control unit) 40. The first holding unit 110 holds the target substrate W of the superposed substrate T, in which the target substrate W (an example of the first substrate) and the support substrate S (an example of the second substrate) are joined. The plurality of suction moving units 210, 220 and 230 suction-hold the support substrate S of the superposed substrate T and move the support substrate S in the direction away from the surface of the target substrate W. The measurement units 240 and 250 detect a peeled-off state of the support substrate S from the target substrate W. The control device 40 controls the operation timings of the suction moving units 210, 220 and 230 so that the support substrate S is peeled off from the target substrate W gradually from the one end S1 of the support substrate S toward the other end S2 thereof, based on the peeled-off state detected by the measurement units 240 and 250.

Therefore, the peeling device 5 according to the first embodiment makes it possible to promote efficiency of the peeling process. The peeling device 5 according to the first embodiment also makes it possible to separate the superposed substrate T into the support substrate S and the target substrate W without applying large loads to the second and third suction moving units 220 and 230 and the support substrate S. Further, the superposed substrate T can be separated in a short time.

Also, in the peeling device 5 according to the first embodiment, the peeling inducement unit 190 is provided with the sharp member 191, and the moving mechanism 192 configured to move the sharp member 191 toward the lateral side of the superposed substrate T adjacent to the one end S1, specifically, the lateral side of the support substrate S in the vicinity of the adhesive G at which the target substrate W and the support substrate S are joined. In addition, there is less possibility for the sharp member 191 to come into contact with the target substrate W to damage the target substrate W.

The configuration of the state detection units is not limited to that shown in the first embodiment. For example, the state detection units may be displacement detection units 260 and 270, as shown by the imaginary lines in FIG. 3B, configured to detect displacements of the first and second suction moving units 210 and 220, specifically displacements of the suction pads 211 and 221 of the first and second suction moving units 210 and 220. The displacement detection units 260 and 270 may be, for example, encoders. That is, the peeled-off state is determined based on the fact that the displacements of the first and second suction moving units 210 and 220 are increased as the support substrate S is peeled off.

In such a case, when the displacement of the suction pad 211 detected by the displacement detection unit 260 increases to be equal to or larger than a threshold value by the first suction moving unit 210 moving the support substrate S in the direction away from the target substrate W, the control device 40 determines that the support substrate S has been peeled off up to a predetermined position between the peripheral portion adjacent to the one end S1 and the region in the vicinity of the central portion.

In the same way, when the displacement of the suction pads 221 detected by the displacement detection unit 270 increases to be equal to or larger than a threshold value by the second suction moving units 220 moving the support substrate S in the direction away from the target substrate W, the control device 40 determines that the support substrate S has been peeled off up to a predetermined position between the region in the vicinity of the central portion and the peripheral portion adjacent to the other end S2.

In addition, the state detection units may be load detection units 280 and 290, as shown by imaginary lines in FIG. 3B, configured to detect loads applied to the first and second suction moving units 210 and 220 due to the support substrate S when the support substrate S is moved in the direction away from the surface of the target substrate W. The load detection units 280 and 290 may be, for example, load cells. That is, the peeled-off state is determined using the fact that the loads applied to the first and second suction moving units 210 and 220 are reduced as the support substrate S is peeled off.

In such a case, when the load detected by the load detection unit 280 decreases to be less than a threshold value by the first suction moving unit 210 moving the support substrate S in the direction away from the target substrate W, the control device 40 determines that the support substrate S has been peeled off up to a predetermined position between the peripheral portion adjacent to the one end S1 and the region in the vicinity of the central portion.

In the same way, when the load detected by the load detection unit 290 is reduced and is less than a threshold value by the second suction moving units 220 moving the support substrate S in the direction away from the target substrate W, the control device 40 determines that the support substrate S has been peeled off up to a predetermined position between the region in the vicinity of the central portion and the peripheral portion adjacent to the other end S2.

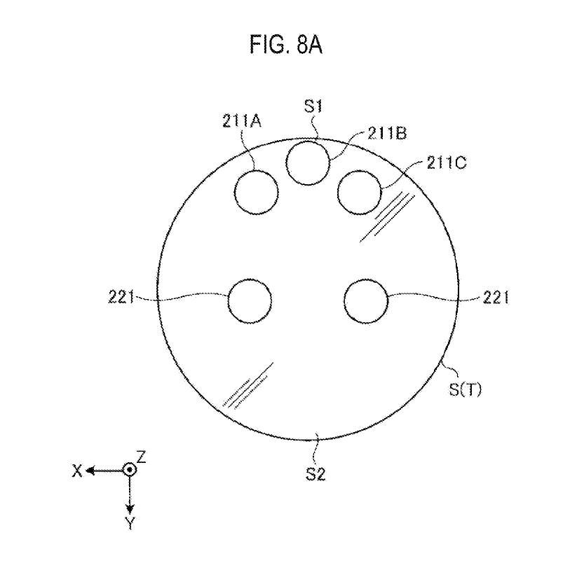

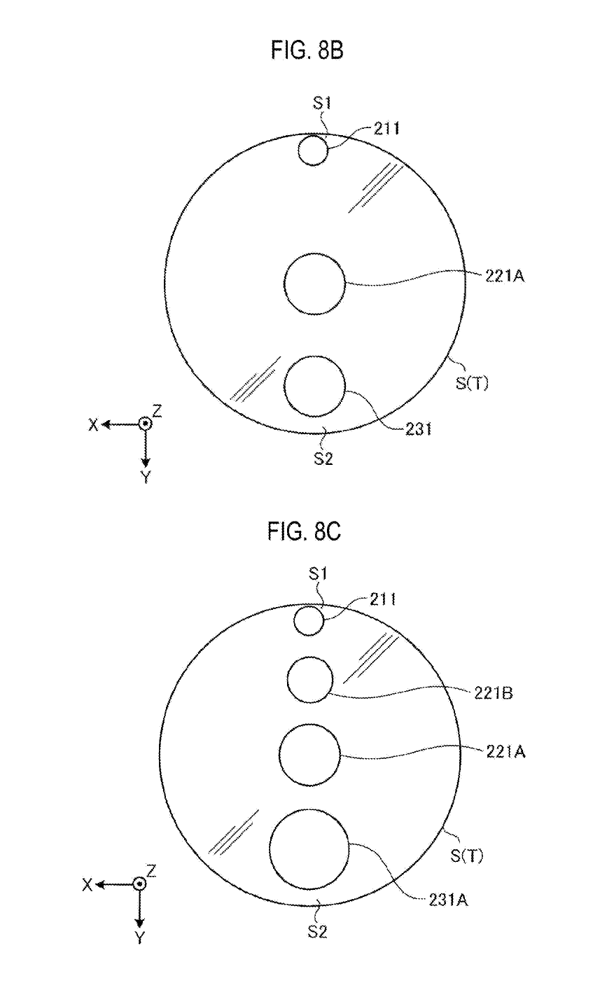

In addition, the configuration of the second holding unit is not limited to that shown in the first embodiment. Therefore, hereinafter, modified examples of the second holding unit will be described with reference to FIGS. 8A to 8C. FIGS. 8A to 8C are schematic plan views showing the modified examples of the second holding unit.

The above-described first embodiment has shown an example in which the first suction moving unit suction-holds the peripheral portion of the support substrate S adjacent to the one end S1 at one place, but, for example, the first suction moving unit may suction-hold the peripheral portion at a plurality of places.

Specifically, as shown in FIG. 8A, suction pads 211A, 211B and 211C of the first suction moving unit 210 may be disposed at a plurality of (for example, three) places along the peripheral portion of the support substrate S adjacent to the one end S1. As described above, as the support substrate S is suction-held by the plurality of suction pads 211A, 211B and 211C, it is possible to securely peel off the side of the support substrate S adjacent to the one end S1 from the target substrate W.

In addition, as shown in FIG. 8A, the third suction moving unit may be omitted. With this configuration, the second holding unit may be simplified in configuration. Also, although FIG. 8A shows that the third suction moving unit is omitted, this is only for illustrative purposes and the third suction moving unit may not be omitted.

In FIG. 8A, the suction pads 211A, 211B, 211C and 221 are configured to have substantially the same suction area. With this configuration, for example, the suction pads can be commonized. Here, while it has been described as an example that the suction pads 211A, 211B, 211C and 221 have substantially the same suction area, the present disclosure is not limited thereto and the suction areas thereof may be different from one another.

Further, although the above-described first embodiment has shown an example in which the second suction moving units suction-hold the vicinity of the central portion of the support substrate S at a plurality of (two) places, only the central portion of the support substrate S may be suction-held by the second suction moving unit.

Specifically, as shown in FIG. 8B, a suction pad 221A may be disposed at the central portion of the support substrate S and suction-hold the central portion. Accordingly, the configuration of the second holding unit can be simplified.

Further, in the second holding unit, a plurality of second suction moving units may be arranged in a straight line parallel to the direction (the Y axis direction) from the one end S1 toward the other end S2, and the suction-held regions may also be gradually increased from the one end S1 toward the other end S2.

For example, as shown in FIG. 8C, the second holding unit is provided with a suction pad 221A disposed at the central portion of the support substrate S and a suction pad 221B disposed between the suction pad 221A and the suction pad 211. In addition, the suction pads 211, 221B, 221A and 231A have suction areas increasing from the one end S1 toward the other end S2, respectively.

With this configuration, as the peeling off of the support substrate S progresses, since the support substrate S is suction-held by the suction pad having a larger suction area, the support substrate S can be efficiently peeled off and the support substrate S that has been peeled off can be securely held by the second holding unit. In addition, the configuration of the second holding unit is not limited to the above-described examples, and, for example, the third suction moving unit 230 may be omitted to have a simplified peeling system 1.

In addition, the peeling device 5 according to the first embodiment may also be provided with a peeling completion detection unit configured to detect the completion of the peeling off of the entire joint surface Sj of the support substrate S joined to the target substrate W therefrom. Hereinafter, still another modified example of the peeling device 5 according to the first embodiment will be described.

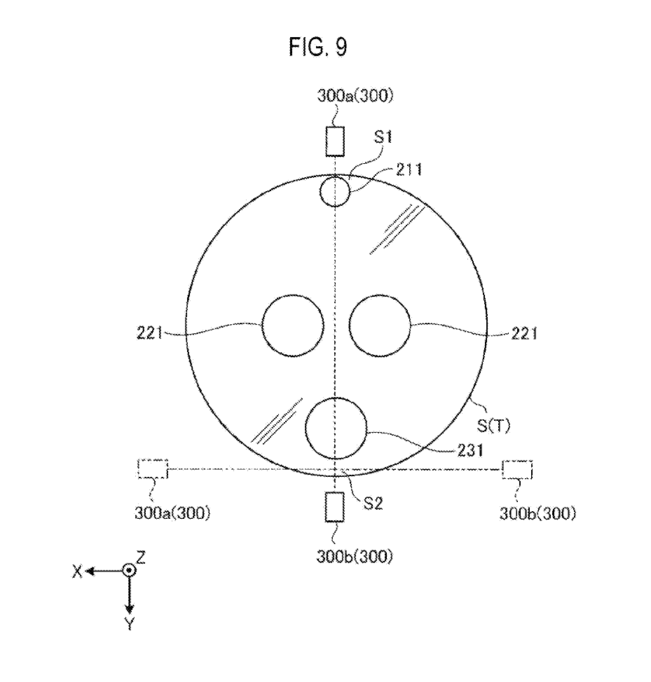

FIG. 9 is a schematic plan view illustrating a positional relationship between the support substrate S, the suction pad 211 of the first suction moving unit 210, the suction pads 221 of the second suction moving units 220, the suction pad 231 of the third suction moving unit 230, and a peeling completion detection unit 300, in the modified example of the peeling device 5 according to the first embodiment.

The peeling completion detection unit 300 is, for example, a photoelectric sensor. As shown in FIG. 9, specifically, the peeling completion detection unit 300 is provided with a light emitting unit (light emitting unit for detecting completion of the peeling) 300a, which is disposed in the vicinity of the one end S1 of the support substrate S and emits light toward the joined portion (for example, the adhesive G) of the target substrate W and the support substrate S in a direction parallel to the direction from the one end S1 toward the other end S2. In addition, the peeling completion detection unit 300 is provided with a light receiving unit (light receiving unit for detecting completion of the peeling) 300b, which is disposed opposite to the light emitting unit 300a with the superposed substrate T interposed therebetween, i.e., in the vicinity of the other end S2, and receives the light from the light emitting unit 300a. In FIG. 9, the light is represented by a broken line.

In detail, when the entire joint surface Sj of the support substrate S joined to the target substrate W has been completely peeled off from the target substrate W, a gap is formed between the support substrate S and the target substrate W. The light receiving unit 300b is disposed at a position where it can receive the light from the light emitting unit 300a when the gap is formed. In addition, when receiving the light, the light receiving unit 300b transmits a signal of the light reception to the control device 40.

With this configuration, the control device 40 can determine whether or not the support substrate S has been completely peeled off, based on a detection result of the peeling completion detection unit 300. That is, when the light receiving unit 300b does not receive the light, the control device 40 determines that the support substrate S is not completely peeled off, while when the light receiving unit 300b receives the light, the control device 40 determines that the support substrate S has been completely peeled off. In addition, the arrangement of the light emitting unit 300a and the light receiving unit 300b is not limited to the illustrated example. For example, the light emitting unit 300a and the light receiving unit 300b may be disposed at the vicinity of the other end S2 and the vicinity of the one end S1, respectively.

With this configuration, the completion of the peeling off of the support substrate S via the peeling process may be determined with an easy and simple configuration in the peeling device 5. In addition, the configuration of the peeling completion detection unit 300 is not limited to the above.

That is, as shown by the imaginary lines in FIG. 9, the light emitting unit 300a and the light receiving unit 300b may be disposed, for example, in such a way that light parallel to the X axis direction passes through a joined portion at which the other end S2 of the support substrate W being lastly subjected to the peeling off joins the corresponding portion of the target substrate W. Even in this configuration, since the light reception by the light receiving unit 300b means that the other end S2 of the support substrate S has been peeled off from the target substrate W, the control device 40 can determine that the support substrate S has been completely peeled off.

The completion of the peeling off of the support substrate S may also be detected based on the distance d2 measured by the measurement unit 250. Specifically, for example, when the distance d2 is less than a threshold value (hereinafter referred to as “threshold value D3”; not shown) by the third suction moving unit 230 moving the support substrate S in the direction away from the surface of the target substrate W, the control device 40 may determine that the support substrate S has been completely peeled off. The threshold value D3 is set to a value less than the above-described threshold value D2.

In addition, while the peeling process is being performed, the control device 40 of the peeling device 5 may control, for example, the operation of the second holding unit 150 based on the detection result of the peeling completion detection unit 300 peeling process. That is, in the peeling process, for example, if before the third suction moving unit 230 suction-holds the support substrate S, the support substrate S is completely peeled off, then, the third suction moving unit 230 need not suction-hold the support substrate S.

Therefore, a configuration is possible where, when it is determined that the support substrate S has been completely peeled off, the control device 40 of the peeling device 5 stops the remaining suction moving units, i.e., the suction moving units before the suction-holding, from suction-holding the support substrate S and terminates the peeling process.

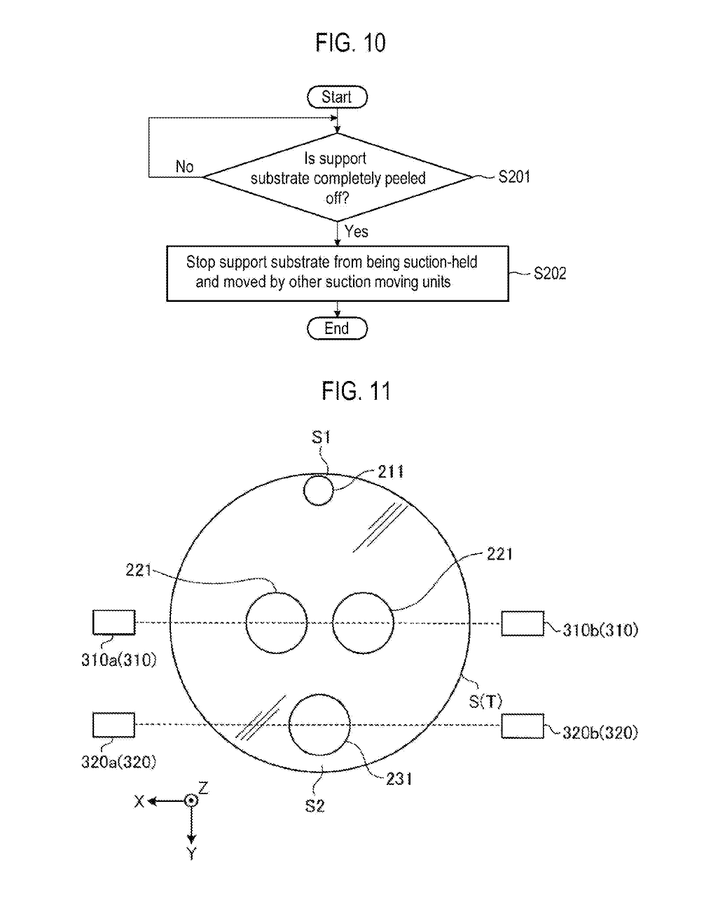

FIG. 10 is a flowchart illustrating processing sequences of the peeling process based on a detection result of the peeling completion detection unit 300. In addition, the processing of FIG. 10 is performed parallel to the processing of the flowchart of FIG. 6 by the control device 40 of the peeling device 5.

First, before all the suction moving unites, e.g., first to third suction moving units 210, 220 and 230 suction-hold the support substrate S and move it in the direction away from the surface of the target substrate W, specifically, before performing the processing of Step S112 of FIG. 6, the peeling device 5 determines whether or not the support substrate S has been completely peeled off based on the detection result of the peeling completion detection unit 300 (Step S201).

When it is determined that the support substrate S is not completely peeled off (Step S201, “No”), the peeling device 5 repeats the processing of Step S201. On the contrary, when it is determined that the support substrate S has been completely peeled off (Step S201, “Yes”), the peeling device 5 terminates the peeling off of the support substrate S from the target substrate W by stopping the other suction moving units from suction-holding the support substrate S and moving it in the direction away from the surface of the target substrate W (Step S202). In Step S202, for example, when the peeling process is completed before performing the operations after Step S111 of FIG. 6, the peeling off of the support substrate S from the target substrate W is terminated by stopping the third suction moving unit 230 from suction-holding the support substrate S and moving it in the direction away from the surface of the target substrate W (i.e., the operations after Step S111 of FIG. 6).

With this configuration, for example, if the support substrate S is completely peeled off before the third suction moving unit 230 operates, the time required for performing the peeling process can be reduced in that the third suction moving unit 230 does not operate.

### Second Embodiment

FIG. 11 is a schematic plan view illustrating a positional relationship between the support substrate S, the suction pad 211 of the first suction moving unit 210, the suction pads 221 of the second suction moving units 220, the suction pad 231 of the third suction moving unit 230 and state detection units 310 and 320, in a peeling system 1 according to a second embodiment. Hereinafter, the same reference numerals are given to the same components as the first embodiment, a description thereof will be omitted.

The following description will be focused on differences from the first embodiment. The peeling system 1 according to the second embodiment is provided with state detection units 310 and 320 having a configuration different from that of the first embodiment, which detect a peeled-off state of the support substrate S from the target substrate W.

Specifically, the state detection units 310 and 320 are, for example, photoelectric sensors. As shown in FIG. 11, all the state detection units 310 and 320 are respectively provided with light emitting units 310a and 320a configured to emit light toward the joined portion of the target substrate W and the support substrate S in the direction (the X axis direction) intersecting the direction (the Y axis direction) from the one end S1 of the support substrate S toward the other end S2 thereof. In addition, all the state detection units 310 and 320 are provided with light receiving units 310b and 320b, which are disposed opposite to the light emitting units 310a and 320a with the superposed substrate T interposed therebetween and receive the light from the light emitting units 310a and 320a, respectively.

In addition, the state detection unit 310 has the light emitting unit 310a and the light receiving unit 310b, which are disposed in such a way that the light parallel to the X axis direction passes through a joined portion at which regions of the support substrate S that is suction-held by the suction pads 221 of the second suction moving units 220 join corresponding regions of the target substrate W.

Also, the state detection unit 320 has the light emitting unit 320a and the light receiving unit 320b, which are disposed in such a way that the light parallel to the X axis direction passes through a joined portion at which a region of the support substrate S that is suction-held by the suction pad 231 of the third suction moving unit 230 joins a corresponding region of the target substrate W. When receiving the light, the light receiving units 310b and 320b disposed as described above transmit signals of the light reception to the control device 40.

With this configuration, the control device 40 may determine a peeled-off state of the support substrate S, based on the detection results of the state detection units 310 and 320. That is, for example, when the light receiving unit 310b of the state detection unit 310 receives the light after the first suction moving unit 210 starts to move the support substrate S in the direction away from the target substrate W, the control device 40 determines that the region of the support substrate S suction-held by the second suction moving units 220 has been peeled off from the target substrate W.

Also, for example, when the light receiving unit 320b of the state detection unit 320 receives the light after the second suction moving units 220 starts to move the support substrate S in the direction away from the target substrate W, the control device 40 determines that the region of the support substrate S suction-held by the third suction moving unit 230 has been peeled off from the target substrate W.

As described above, the peeling system 1 can determine the peeled-off state of the support substrate S and the target substrate W with the state detection units 310 and 320 having an easy and simple configuration as described above. In addition, since other configurations and effects are the same as those of the first embodiment, a description thereof will be omitted.

### Other Embodiments

In the above-described embodiments, it has been described as an example that a superposed substrate to be peeled is the superposed substrate T in which the target substrate W and the support substrate S are joined through the adhesive G. However, the superposed substrate to be peeled by the peeling device is not limited to the superposed substrate T. For example, in the peeling device of each above-described embodiment, a superposed substrate in which a donor substrate having an insulating film formed thereon and a target substrate are joined in order to manufacture an SOI substrate may be an object to be peeled.

Here, a method of manufacturing an SOI substrate will be described with reference to

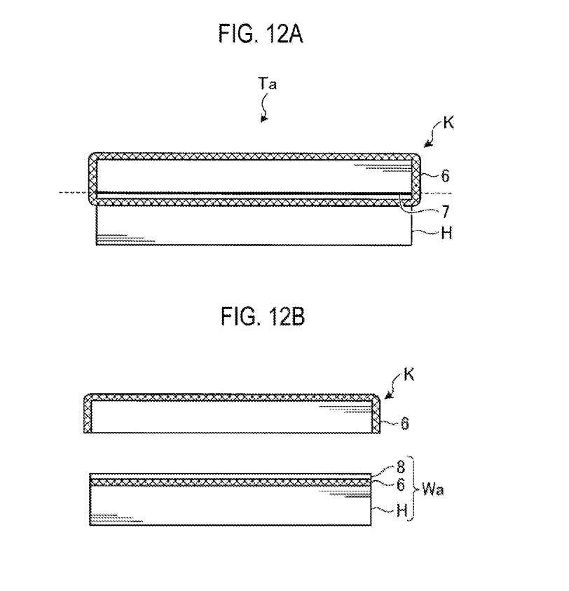

FIGS. 12A and 12B. FIGS. 12A and 12B are schematic views illustrating a manufacturing process of an SOI substrate. As shown in FIG. 12A, a superposed substrate Ta for forming an SOI substrate is formed by joining a donor substrate K and a handle substrate H.

The donor substrate K is a substrate in which an insulating film 6 is formed on a surface thereof and a hydrogen ion injection layer 7 is formed at a predetermined depth in the vicinity of the surface joined to the handle substrate H. In addition, the handle substrate H may include, for example, a silicon wafer, a glass substrate, a sapphire substrate and the like.

In the peeling device according to each of the above-described embodiments, for example, in a state where the first holding unit holds the donor substrate K and the second holding unit holds the handle substrate H, a mechanical impact is applied to the hydrogen ion injection layer 7 formed on the donor substrate K by pulling the peripheral portion of the superposed substrate Ta. Accordingly, as shown in FIG. 12B, silicon-silicon bonding in the hydrogen ion injection layer 7 is broken, and a silicon layer 8 is peeled off from the donor substrate K. As a result, the insulating film 6 and the silicon layer 8 are transferred on an upper surface of the handle substrate H, and an SOI substrate Wa is formed. In addition, although it is preferred that the first holding unit hold the donor substrate K and the second holding unit hold the handle substrate H, the first holding unit may hold the handle substrate H and the second holding unit may hold the donor substrate K.

Further, although it has been described as an example in the above-described embodiments that the target substrate W and the support substrate S are joined with the adhesive G, the joint surfaces Wj and Sj are divided into a plurality of regions and adhesives having different adhesive strengths may be applied to the respective regions.

In addition, although it has been described as an example in the above-described embodiments that the superposed substrate T is held by the dicing frame F, the superposed substrate T need not be held by the dicing frame F.

Additional effects and modifications will readily be recognized and conceivable to those skilled in the art. Therefore, the present disclosure in its broader aspects is not limited to the specific details and representative embodiments shown and described above. Accordingly, various modifications may be made without departing from the spirit or scope of the general inventive concept as defined by the appended claims and their equivalent.

According to the present disclosure, it is possible to promote efficiency of peeling process.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A peeling device, comprising:
a holding unit configured to hold a first substrate of a superposed substrate, the superposed substrate having the first substrate and a second substrate joined;
a plurality of suction moving units configured to suction-hold the second substrate of the superposed substrate and move the second substrate in a direction away from a surface of the first substrate;
a state detection unit configured to detect a peeled-off state of the second substrate from the first substrate; and
a control unit configured to control operation timings of the suction moving units so that the second substrate is peeled off from the first substrate gradually from one end of the second substrate toward the other end thereof, based on the peeled-off state detected by the state detection unit.

2. The peeling device of claim 1, wherein the suction moving units comprise:
a first suction moving unit configured to suction-hold a peripheral portion of the second substrate adjacent to the one end and move the peripheral portion adjacent to the one end in the direction away from the surface of the first substrate; and
a second suction moving unit configured to suction-hold a region in the vicinity of a central portion of the second substrate and move the region in the direction away from the surface of the first substrate,
wherein the control unit operates the first suction moving unit to move the peripheral portion in the direction away from the surface of the first substrate and, after that, the control unit operates the second suction moving unit to move the region in the vicinity of the central portion in the direction away from the surface of the first substrate when the control unit determines that the second substrate has been peeled off up to a predetermined position between the peripheral portion adjacent to the one end and the region in the vicinity of the central portion based on a detection result of the state detection unit.

3. The peeling device of claim 2, wherein the suction moving units further comprise:
a third suction moving unit configured to suction-hold a peripheral portion of the second substrate adjacent to the other end and move the peripheral portion adjacent to the other end in the direction away from the surface of the first substrate, and
wherein the control unit operates the second suction moving unit to move the region in the vicinity of the central portion in the direction away from the surface of the first substrate and, after that, the control unit operates the third suction moving unit to move the peripheral portion adjacent to the other end in the direction away from the surface of the first substrate when the control unit determines that the second substrate has been peeled off up to a predetermined position between the region in the vicinity of the central portion and the peripheral portion adjacent to the other end based on the detection result of the state detection unit.

4. The peeling device of claim 2, wherein a plurality of the second suction moving units are arranged and disposed in a direction intersecting a direction from the one end toward the other end.

5. The peeling device of claim 1, wherein when the control unit determines that at least one region of the second substrate to be suction-held by the suction moving units has been peeled off from the first substrate based on the detection result of the state detection unit, the control unit operates the suction moving unit corresponding to the region to move the region in the direction away from the surface of the first substrate.

6. The peeling device of claim 1, wherein the state detection unit is a measurement unit configured to measure a distance from a predetermined measurement reference position to the second substrate.

7. The peeling device of claim 1, wherein the state detection unit comprises:
a light emitting unit configured to emit light toward a joined portion of the first substrate and the second substrate in a direction intersecting a direction from the one end toward the other end; and
a light receiving unit configured to receive the light from the light emitting unit, the light receiving unit being disposed opposite the light emitting unit with the superposed substrate interposed therebetween.

8. The peeling device of claim 1, wherein the state detection unit is a displacement detection unit configured to detect a displacement of the suction moving unit.

9. The peeling device of claim 1, wherein the state detection unit is a load detection unit configured to detect a load applied to the suction moving unit for the second substrate when the second substrate is moved in the direction away from the surface of the first substrate.

10. The peeling device of claim 1, further comprising a peeling completion detection unit configured to detect whether an entire joint surface of the second substrate joined to the first substrate is completely peeled off from the first substrate.

11. The peeling device of claim 10, wherein the peeling completion detection unit comprises:
a peeling-completion detection light emitting unit configured to emit light toward a joined portion of the first substrate and the second substrate in a direction parallel to a direction from the one end toward the other end; and
a peeling-completion detection light receiving unit configured to receive the light from the peeling-completion detection light emitting unit, the peeling-completion detection light receiving unit being disposed opposite the peeling-completion detection light emitting unit with the superposed substrate interposed therebetween.

12. The peeling device of claim 10, wherein when the control unit determines that the second substrate has been completely peeled off based on the detection result of the peeling completion detection unit before all the plurality of suction moving units suction-hold the second substrate and move the second substrate in the direction away from the surface of the first substrate, the control unit stops the suction moving units before suction-holding the second substrate from suction-holding the second substrate and moving the second substrate in the direction away from the surface of the first substrate to terminate the peeling off of the second substrate from the first substrate.

13. The peeling device claim 1, further comprising a peeling inducement unit configured to form a region at which the peeling off of the second substrate from the first substrate is initiated, in a lateral side of the superposed substrate adjacent to the one end.

14. The peeling device of claim 13, wherein the peeling inducement unit comprises:
a sharp member; and
a moving mechanism configured to move the sharp member toward a lateral side of the second substrate in the vicinity of a joined portion of the first substrate and the second substrate.

15. A peeling system, comprising:
a carry-in/carry-out station in which a superposed substrate is mounted, the superposed substrate having a first substrate and a second substrate joined;
a substrate transfer device configured to transfer the superposed substrate mounted in the carry-in/carry-out station; and
a peeling station provided with a peeling device configured to peel off the first substrate and the second substrate from the superposed substrate transferred by the substrate transfer device,
wherein the peeling device comprises:
a holding unit configured to hold the first substrate of the superposed substrate;
a plurality of suction moving units configured to suction-hold the second substrate of the superposed substrate and move the second substrate in a direction away from a surface of the first substrate;
a state detection unit configured to detect a peeled-off state of the second substrate from the first substrate; and
a control unit configured to control operation timings of the suction moving units so that the second substrate is peeled off from the first substrate gradually from one end of the second substrate toward the other end thereof, based on the peeled-off state detected by the state detection unit.

16. A peeling method, comprising:
holding a first substrate of a superposed substrate by a holding unit, the holding unit being configured to hold the first substrate of the superposed substrate, and the superposed substrate having the first substrate and a second substrate joined;
detecting a peeled-off state of the second substrate from the first substrate; and
controlling operation timings of a plurality of suction moving units so that the second substrate is peeled off from the first substrate gradually from one end of the second substrate toward the other end thereof by the plurality of suction moving units, based on the peeled-off state detected in the detecting process, the plurality of suction moving units being configured to suction-hold the second substrate of the superposed substrate and move the second substrate in a direction away from a surface of the first substrate.
